(19) United States
(12) Patent Application Publication
(10) Pub. No.: US 2004/0234696 A1
(43) Pub. Date: Nov. 25, 2004

(54) Plating device and method

(76) Inventors: Akihisa Hongo, Tokyo (JP); Xinming Wang, Tokyo (JP); Naoki Matsuda, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/482,477

(22) PCT Filed: Aug. 12, 2002
(86) PCT No.: PCT/JP02/08213

(30) Foreign Application Priority Data
Aug. 10, 2001 (JP) 2001-243534
Sep. 5, 2001 (JP) 2001-268640
Oct. 17, 2001 (JP) 2001-319837

(51) Int. Cl. B05D 1/18; B05D 3/00; B05C 3/00

(52) U.S. Cl. 427/328; 427/430.1; 118/400

(57) ABSTRACT

There is provided a plating device that can easily form a uniform plated film on the surface, to be plated, of a material. The plating device includes: a holder for holding a material with its surface, to be plated, upward and its peripheral portion of the surface, to be plated, sealed; a heated fluid holding section for holding a heated fluid which is allowed to come into contact with the back surface of the material held by the holder to heat the material; and a plating solution supply section for supplying a plating solution to the surface, to be plated, of the material held by the holder.

### TECHNICAL FIELD

This invention relates to a plating device and method. More particularly, this invention relates to an electroless plating device and method useful for forming an embedded interconnects that an electric conductor, such as copper or silver, is imbedded in fine recesses for interconnects formed in the surface of a substrate like a semiconductor substrate, and for forming a protective layer for protecting the surface of the interconnects formed in this way.

### BACKGROUND ART

An electroless plating is such a method that a plated film is formed on a surface, to be plated, of a material by chemically reducing metal ions in a plating solution without supplying any electric current from the outside, and the electroless plating is widely used in a nickel-phosphorus plating and a nickel-boron plating for giving a corrosion resistance and a wear resistance, and a copper plating for a printed-wiring substrate.

As an electroless plating device, there has been generally known an device comprising a plating bath for holding an electroless plating solution, and a vertically movable holding portion disposed above the plating bath for holding a material, to be plated, such as a substrate so as to face downwardly (face down), whereby the material held by the holding portion is dipped into the plating solution in the plating bath. Further, there has been also generally known a plating device comprising a holding portion for holding a material, to be plated, such as a substrate so as to face upwardly (face, up), and a plating solution supply portion (nozzle) for supplying a plating solution to an upper surface (surface to be plated) of the material held by the holding portion, whereby the plating solution flows along the upper surface of the material, to be plated, held by the holding portion.

In recent years, as the processing speed and integration of a semiconductor chip becomes higher, there has been a growing tendency to replace aluminum or aluminum alloy with copper having a low electric conductivity and a high electromigration resistance as metallic materials for forming interconnection circuits on the semiconductor substrate. This kind of copper interconnects are generally formed by filling fine recesses formed in the surface of the substrate with copper. As a method for forming the copper interconnects, CVD, sputtering, and plating are known, but plating is generally used. In any case, after a copper film is deposited on the surface of the substrate, the surface of the substrate is polished to a flat finish by chemical mechanical polishing (CMP) process.

In the case of interconnects formed by such a process, the embedded interconnects have an exposed surface after the flattening processing. When an additional embedded interconnect structure is formed on such an exposed surface of interconnects of a semiconductor substrate, the following problems may be encountered. For example, during the formation of a new SiO₂ interlevel dielectric, the exposed surface of the pre-formed interconnects is likely to be oxidized. Further, upon etching of the SiO₂ layer for the formation of contact holes, the pre-formed interconnects exposed at the bottoms of the contact holes can be contaminated-with an etchant, a peeled resist, etc. Moreover, in the case copper interconnects, there is a fear of copper diffusion.

In view of this, in the case of copper interconnects, for example, it may be considered to selectively cover the surface of copper interconnects with a protective layer (plated film) of a Ni—P alloy or the like, having a good adhesion to copper and a low resistivity (p). Ni—B alloy layer can be formed on the surface of e.g. copper selectively by using an electroless plating solution which contains nickel ions, a complexing agent for nickel ions and an alkylamine borane or a borohydride compound as a reducing agent for nickel ions and by immersing the surface of the substrate in the electroless plating solution.

An electroless plating is applied to main filling materials (Cu) for the copper interconnects, the formation of the seed layer on the barrier metal, or the reinforcement of the seed (Cu), further the formation of the barrier metal itself, or the formation of cap material for the copper interconnect (in any case, Ni—P, Ni—B, Co—P, Ni—W—P, Ni—Co—P, Co—W—P), or the like. In any electroless plating process, uniformity of the film thickness over an entire surface of the substrate is required.

In electroless plating, when a surface, to be plated, of a material is brought into contact with an electroless plating solution, a plating metal instantly begins to deposit on the surface, to be plated, of the material, and the deposition rate of the plating metal varies depending on the temperature of the plating solution. Accordingly, in order to form a plated film having a uniform film thickness on the surface, to be plated, of a material, the temperature of a plating solution is required to be uniform all over the surface of the material from the initial time of contact between the material and the plating solution, and the uniform plating temperature must be kept throughout the plating treatment.

In conventional electroless plating devices, a material to be processed is held on the upper or lower surface of a holder having a built-in heater, and the surface, to be plated, of the material is allowed to be in contact with an electroless plating solution heated to a predetermined temperature while the material is kept heated by the heater. Due to the irregularities of the material to be processed and the surface roughness of the holder, air maybe present between the material and the holder. Partly because the air functions as a heat insulating material, heat conduction between the solids, the material to be processed and the holder, is likely to be uneven. In addition, a Teflon sheet or the like, having poor heat conductivity, is generally attached to the surface of the holder. Accordingly, the temperature of the material to be processed is likely to be uneven during plating. That is, it is difficult to keep the material at a uniform temperature over the entire surface during plating.

The rate of electroless plating and the quality of plated film depend largely on the temperature of electroless plating solution. In order to secure uniformity of the film thickness over the entire surface of a material to be processed, it is desired to control the variation of the plating solution temperature within the range of ±1° C. over the entire surface of the material to be processed. However in the case of an electroless plating device utilizing a face-down system, since the holder holding a material, to be processed, is at normal temperature before plating, there may locally occur a slow temperature rise in the portion of the material in contact with the holder at the initial stage of plating. In the case of an electroless plating device utilizing a face-up system, on the other hand, it is difficult to keep a plating solution at a predetermined temperature until it reaches the surface, to be plated, of the material. Thus, according to conventional electroless plating devices, a temperature variation in the order of ±5° C. is generally produced during plating in the plating solution in contact with a material to be processed, and hence it is difficult to meet the ±1° C. variation requirement. The uneven plating temperature problem holds also for conventional electroplating devices.

Furthermore, an electroless plating device utilizing a face-down system also has the drawback that hydrogen gas generated during plating is hardly released from the surface, to be plated, of a material, resulting in the formation of a non-plated spot in the plated surface. In addition, good or poor results of plating is sensitively influenced by fluid factors, such as the flow rate of plating solution, the rotating speed of a material to be processed, etc. An electroless plating device utilizing a face-up system has the problem that good or poor results of plating is sensitively influenced by the movement of a plating solution supply portion (nozzle).

### DISCLOSURE OF INVENTION

The present invention has been made in view of the above situation in the related art. It is therefore an object of the present invention to provide a plating device and method which can easily form a uniform plated film on the surface, to be plated, of the substrate.

In order to achieve the above object, the present invention provides a plating device, comprising: a processing bath for holding a processing solution to process the substrate by contacting the substrate with the processing solution; and a substrate holder for holding a substrate in such a state that a back surface of the substrate is sealed and a surface to be plated is brought into contact with the processing solution; wherein the processing bath has a fluid holding section for holding a fluid having a predetermined temperature which contacts the back surface of the substrate.

When the fluid having a predetermined temperature is brought into contact with the back surface of a substrate, to be processed, to heat the substrate, the fluid having a predetermined temperature well follows the irregularities of the back surface of the substrate and contacts the entire surface, enabling an efficient heat transfer to the substrate with an increased contact area. Further, by utilizing as a heat source a fluid having a high heat capacity, the substrate can be heated more uniformly in a short time. For example, by bringing a hot water controlled at 60° C. into contact with the back surface of a semiconductor wafer, the semiconductor wafer can be heated so that the surface temperature reaches 60° C. in about 2-3 seconds. Moreover, since the substrate is not wholly immersed in the plating solution, the management of the plating solution can be made with ease.

The substrate holder is preferably rotatable and vertically movable. This makes it possible to lower the substrate holder so as to bring the back surface of the substrate held by the substrate holder into contact with the fluid having a predetermined temperature. Further, by rotating the substrate holder, it becomes possible to uniformly wet the surface, to be plated, of the substrate held by the substrate holder with the plating solution supplied to the surface, to be plated, and to carry out draining of the plating solution after plating.

It is also preferred that the substrate holder be tiltable. This makes it possible to tilt the substrate held by the substrate holder relative to the surface of the heated fluid when bringing the back surface of the substrate into contact with the fluid having a predetermined temperature, and then return the substrate to a horizontal position, thereby preventing air bubbles from remaining on the back surface of the substrate. Further, by tilting again the substrate after completion of plating, the plating solution remaining on the plated surface of the substrate can be gathered up, facilitating discharge of the plating solution.

The plating device may further comprise a head section that can move vertically and can move between a position above the substrate holder at which the head section covers the substrate holder and a retreat position. A plating solution supply nozzle may be provided in the head section. The head section may be located in the position covering the substrate held by the substrate holder during plating, and may be moved to the retreat position after plating, whereby the head section can be prevented from impeding transfer of the substrate.

Preferably, the head section is also provided with a plating solution holding for supplying a predetermined amount of plating solution to the surface of the substrate held by the substrate holder, and a mechanism for keeping the plating solution held in the plating solution holding bath at a predetermined temperature. In carrying out copper plating to form a protective film, e.g. by electroless plating, on a semiconductor wafer, the necessary amount of plating solution is about 100-200 cc for a wafer with a diameter of 200 mm, and about 200-400 cc for a water with a diameter of 300 mm. Such an amount of plating solution, which is kept at a constant temperature, can be supplied, by free fall, to the surface, to be plated, of the substrate in a moment of time (e.g. 1-5 seconds).

Preferably, the head section is also provided with a pre-plating treatment liquid holding bath for holding a pre-plating treatment liquid and supplying the pre-plating treatment liquid to the surface, to be plated, of the substrate held by the substrate holder. A cleaning liquid for carrying out pre-plating cleaning or a catalyst-imparting liquid for carrying out a catalyst-imparting treatment may be used as the pre-plating treatment liquid. By the provision of the pre-plating treatment liquid holding bath in the head section, a pre-plating treatment, such as cleaning or a catalyst-imparting treatment, and a plating treatment can be carried out successively in one bath onto the surface, to be plated, of the substrate hold by the substrate holder. Specific examples of the cleaning liquid include H₂SO₂, HF, HCl, NH₃, DMAH (dimethylamine borane) and oxalic acid. Specific examples of the catalyst-imparting liquid include PdSO₄ and PdCl₂.

Preferably, the head section is also provided with a pure water supply nozzle for supplying pure water to the surface of the substrate held by the substrate holder. This makes it possible to carry out a plating treatment and a rinsing treatment with pure water after the plating treatment successively in one bath.

The plating device also preferably comprises a plating solution recovery nozzle for recovering the plating solution supplied to the surface of the substrate held by the substrate holder. By recovering the plating solution by the plating solution recovering nozzle and reusing the recovered plating solution, the amount of plating solution used can be reduced, whereby the running cost can be lowered.

Preferably, the plating device further comprises an inert gas introduction section for introducing an inert gas adjusted at a predetermined temperature into the space between the substrate held by the substrate holder and the head section, which is in the position covering the upper surface of the substrate. Thus, an inert gas can be introduced, during plating, into the space between the substrate held by the substrate holder and the head section that covers the upper surface of the substrate, whereby the space is brought to the inert gas atmosphere at a predetermined temperature. This can effectively prevent air contacting the surface of the plating solution. In this regard, if air contacts the surface of the plating solution, oxygen in the air is taken in the plating solution to increase the amount of dissolved oxygen in the plating solution, which would restrain the reducing action based on a reducing agent, leading to poor deposition of the plating. Such a drawback can be obviated by bringing the above space to an inert gas atmosphere. Further, by keeping the space under the atmosphere of an inert gas heated to a predetermined temperature, lowering of the plating solution temperature during plating can be prevented. Moreover, in the case of using a reducing agent susceptible to self-degradation (e.g. DMAB and GOA), prevention of its contact with air can prolong the life of the plating solution. The inert gas may, for example, be N₂ gas. When the temperature of the plating solution is 70° C., for example, the temperature of the inert gas is generally 60 to 70° C., preferably 65 to 70° C.

It is preferable that the plating device further comprise a cleaning liquid introduction section for allowing a cleaning liquid to flow through the plating solution holding bath and the plating solution supply nozzle to clean them. Extraneous matters adhering to the inner wall surfaces of the plating solution holding bath and the plating solution supply nozzle can thus be cleaned off. The cleaning may be practiced periodically or at an arbitrary time. Pure water or a cleaning chemical, such as HNO₃, aqua regia or HF, may be used as the cleaning liquid.

The present invention provides another plating device, comprising: a processing bath for holding a processing solution to process the substrate by contacting the substrate with the processing solution; a substrate holder for holding a substrate in such a state that a back surface of the substrate is sealed and a surface to be plated is brought into contact with the processing solution; a heater for heating the substrate held by the substrate holder; a plating solution supply section for supplying a plating solution to the surface of the substrate held by the substrate holder; and a cover body which can cover the surface of the substrate held by the substrate holder.

According to this plating device, the cover body can prevent heat radiation from the surface, to be plated, of the substrate during plating and keep the substrate at a more uniform temperature during plating. Further, by opening the cover body when moving up and down the substrate held by the substrate holder, the cover body can be prevented from impeding the operation.

The present invention provides still another plating device, comprising: a processing bath for holding a processing solution to process the substrate by contacting the substrate with the processing solution; a substrate holder for holding a substrate in such a state that a back surface of the substrate is sealed and a surface to be plated is brought into contact with the processing solution; and a cover body which can cover the surface of the substrate held by the substrate holder, and which is provided with a heater for preventing heat radiation from the plating solution supplied to the surface of the substrate.

According to this plating device, heat radiation from the surface of the plating solution supplied to the surface, to be plated, of the substrate can be suppressed.

The present invention provides a still another plating device, comprising: an upwardly-opened plating bath for holding a heated plating solution; a substrate holder, positioned at the top-opening of the plating bath, for holding a substrate in such a state that a back surface of the substrate is sealed and a surface to be plated is brought into contact with the processing solution; and a mechanism for immersing the substrate held by the substrate holder in a plating solution in the plating bath.

According to this plating device, a so-called face-up system is employed and plating is carried out by immersing a substrate to be processed in a plating solution while the back surface and the peripheral portion of the substrate are kept sealed, whereby hydrogen gas generated during plating can be easily released from the surface, to be plated, of the substrate and plating can be carried out stably.

The substrate holder preferably includes a stage and a holding portion that are vertically movable relative to each other. The substrate can be held by covering the back surface of the substrate with the stage and sealing a peripheral portion of the surface, to be plated, of the substrate with a sealing substrate provided in the holding portion.

The stage preferably has a ring-shaped support frame and a heat conductor in the form of a thin film that is stretched inside the support frame.

According to this preferable embodiment, when immersing the substrate held by the substrate holder in the plating solution, the heat of the plating solution can be conducted via the heat conductor to the substrate, whereby the substrate can be heated. The use as the heat conductor of a thin film enables the heat conductor to follow the irregularities of the back surface of the substrate, thereby increasing the contact area and enhancing the efficiency of heat transfer to the substrate. Further, the use as a heat source of the fluid (plating solution) having a high heat capacity makes it possible to heat the substrate more uniformly in a short time.

Preferably, the substrate holder can move up and down relative to the plating bath, and can stop at a pre-heating position for bringing the heat conductor into contact with the plating solution in the plating bath so as to pre-heat the substrate held by the substrate holder and at a plating position for immersing the substrate in the plating solution in the plating bath to carry out plating.

According to this preferable embodiment, the substrate holder holding the substrate is stopped at the pre-heating position to heat the substrate to a stable temperature, and then the substrate holder is moved to the plating position to carry out plating. This can prevent the local occurrence of a slow temperature rise in the substrate.

Preferably, the plating bath is so constructed that the plating solution is introduced from the bottom of the plating bath into the plating bath, and the plating solution is allowed to overflow the top of the plating bath. This makes it possible to sequentially introduce a plating solution with a controlled component concentration at a controlled temperature into the plating bath and discharge the plating solution out of the plating bath.

The present invention provides a still another plating device, comprising: an upwardly-opened plating bath for holding a heated plating solution; a substrate holder, positioned at the top-opening of the plating bath, for holding a substrate in such a state that a back surface of the substrate is sealed and a surface to be plated is brought into contact with the processing solution; a mechanism for immersing the substrate held by the substrate holder in the plating solution in the plating bath; a chamber for hermetically closing in a space above the plating bath; and an inert-gas introduction portion for introducing an inert gas into the chamber.

According to this plating device, by keeping the space within the chamber under an inert gas atmosphere, the adverse effect of dissolved oxygen in the plating solution on a plated film can be eliminated. The inert gas may, for example, be N₂ gas.

The present invention also provides a plating treatment apparatus, comprising: a pre-plating treatment device for carrying out a pre-plating treatment to activate the surface of a substrate before plating; a plating device for forming a plated film on the activated surface of the substrate; a post-cleaning device for cleaning the surface of the substrate after the plating; a cleaning/drying device for rinsing with pure water the surface of the substrate after the post-cleaning treatment; and a loading/unloading section.

The present invention also provides a plating method, comprising: holding a substrate in such a state that a back surface of the substrate is sealed; pouring a fluid having a predetermined temperature into a fluid holding section so as to contact a back surface of the substrate with the fluid in the fluid holding section; and processing the substrate by contacting the surface of the substrate held the substrate holder with a processing solution.

The present invention also provides another plating method, comprising: holding a substrate by a substrate holder; heating the substrate held by the substrate holder by a plating solution held in a plating bath; and immersing the heated substrate in the plating solution in the plating bath.

Preferably, the substrate, with its surface, to be plated, upward, is placed and held on the upper surface of a heat conductor, and the heat conductor is allowed to be in contact with the plating solution in the plating bath to thereby heat the substrate.

### BRIEF DESCRIPTION OF DRAWINGS

FIGS. 1A through 1D are diagrams illustrating, in sequence of process steps, an example of the formation of copper interconnects by copper plating;

FIG. 2 is a cross-sectional view of an electroless plating device according to an embodiment of the present invention;

FIG. 3 is a plan view of the treatment bath of FIG. 2;

FIG. 4 is a plan view showing the layout of a plating treatment apparatus which is provided with the electroless plating device of FIG. 2;

FIG. 5 is a plan view showing the layout of another plating treatment apparatus which is provided with the electroless plating device of FIG. 2;

FIG. 6 is a cross-sectional view of an electroless plating device according to another embodiment of the present invention;

FIG. 7 is a cross-sectional view of an electroless plating device according to still another embodiment of the present invention;

FIG. 8 is a cross-sectional view of an electroless plating device according to still another embodiment of the present invention;

FIG. 9 shows a modification of the electroless plating device shown in FIG. 8;

FIG. 10 is a flow chart of the process in the controller;

FIG. 11 is a cross-sectional view of an electroless plating device according to still another embodiment of the present invention;

FIG. 12 is a plan view of the electroless plating device of FIG. 11;

FIG. 13 is a flow chart illustrating the process steps of plating treatments as performed by the electroless plating device of FIG. 11;

FIG. 14 is a cross-sectional view of an electroless plating device according to still another embodiment of the present invention, showing the state of the plating device when the substrate holder is in the pre-heating position;

FIG. 15 is a cross-sectional view of the device of FIG. 14, showing the state of the plating device when the substrate holder is in the plating position;

FIG. 16 is a diagram showing the general construction of an electroless plating device according to still another embodiment of the present invention;

FIG. 17 shows an electroless plating apparatus utilizing a face-down system, showing the state of the plating device when the substrate holder is in the non-plating position;

FIG. 18 shows an electroless plating apparatus utilizing a face-down system, showing the state of the plating device when the substrate holder is in the plating position;

FIG. 19 is a plan view of an example of a substrate plating apparatus;

FIG. 20 is a schematic view showing airflow in the substrate plating apparatus shown in FIG. 19;

FIG. 21 is a cross-sectional view showing airflows among areas in the substrate plating apparatus shown in FIG. 19;

FIG. 22 is a perspective view of the substrate plating apparatus shown in FIG. 19, which is placed in a clean room;

FIG. 23 is a plan view of another example of a substrate plating apparatus;

FIG. 24 is a plan view of still another example of a substrate plating apparatus;

FIG. 25 is a plan view of still another example of a substrate plating apparatus;

FIG. 26 is a view showing a plan constitution example of the semiconductor substrate processing apparatus;

FIG. 27 is a view showing another plan constitution example of the semiconductor substrate processing apparatus;

FIG. 28 is a view showing still another plan constitution example of the semiconductor substrate processing apparatus;

FIG. 29 is a view showing still another plan constitution example of the semiconductor substrate processing apparatus;

FIG. 30 is a view showing still another plan constitution example of the semiconductor substrate processing apparatus;

FIG. 31 is a view showing still another plan constitution example of the semiconductor substrate processing apparatus;

FIG. 32 is a view showing a flow of the respective steps in the semiconductor substrate processing apparatus illustrated in FIG. 31;

FIG. 33 is a view showing a schematic constitution example of a bevel and backside cleaning unit;

FIG. 34 is a view showing a schematic constitution of an example of an electroless plating apparatus;

FIG. 35 is a view showing a schematic constitution of another example of an electroless plating apparatus;

FIG. 36 is a vertical sectional view of an example of an annealing unit; and

FIG. 37 is a transverse sectional view of the annealing unit.

### BEST MODE FOR CARRYING OUT THE INVENTION

Preferred embodiments of the present invention will now be described in detail with reference to the accompanying drawings, which in no way limit the invention.

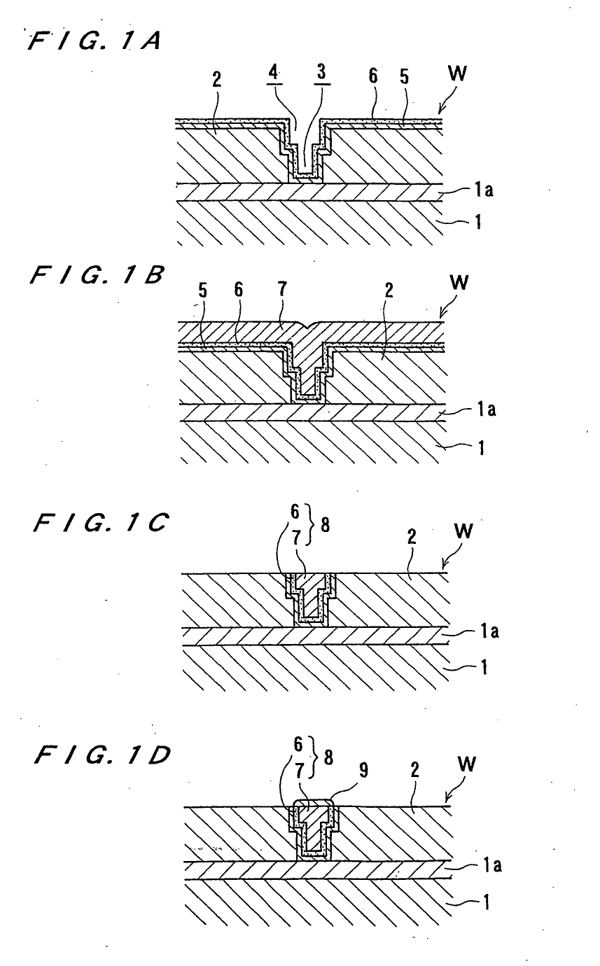

FIGS. 1A through 1D illustrate, in sequence of process steps, an example of the formation of copper interconnects in a semiconductor device. As shown in FIG. 1A, an insulating film 2 of e.g. SiO₂ is deposited on a conductive layer 1a in which semiconductor devices are provided, which is formed on a semiconductor base 1. Contact holes 3 and trenches 4 for interconnects are formed in the insulating film 2 by the lithography/etching technique. Thereafter, a barrier layer 5 of TaN or the like is formed on the entire surface, and a copper seed layer 6 as an electric supply layer for electroplating is formed on the barrier layer 5, for example, by sputtering.

Thereafter, as shown in FIG. 1B, copper plating is carried, out onto the surface of the semiconductor substrate W to fill the contact holes 3 and the trenches 4 with copper and, at the same time, deposit a copper film 7 on the insulating film 2. Thereafter, the copper film 7 and the barrier layer 5 on the insulating film 2 are removed by chemical mechanical polishing (CMP) so as to make the surface of the copper film 7 filled in the contact holes 3 and the trenches 4 for interconnects and the surface of the insulating film 2 lie substantially on the same plane. Interconnects 8 composed of the copper seed layer 6 and the copper film 7, as shown in FIG. 1C, are thus formed in the insulating layer 2. Next, electroless Ni—B plating, for example, is carried out onto the surface of the substrate W to form a protective layer (plated film) 9 composed of a Ni—P alloy selectively on the exposed surface of copper interconnects 8 to protect the interconnects 8, as shown in FIG. 1D.

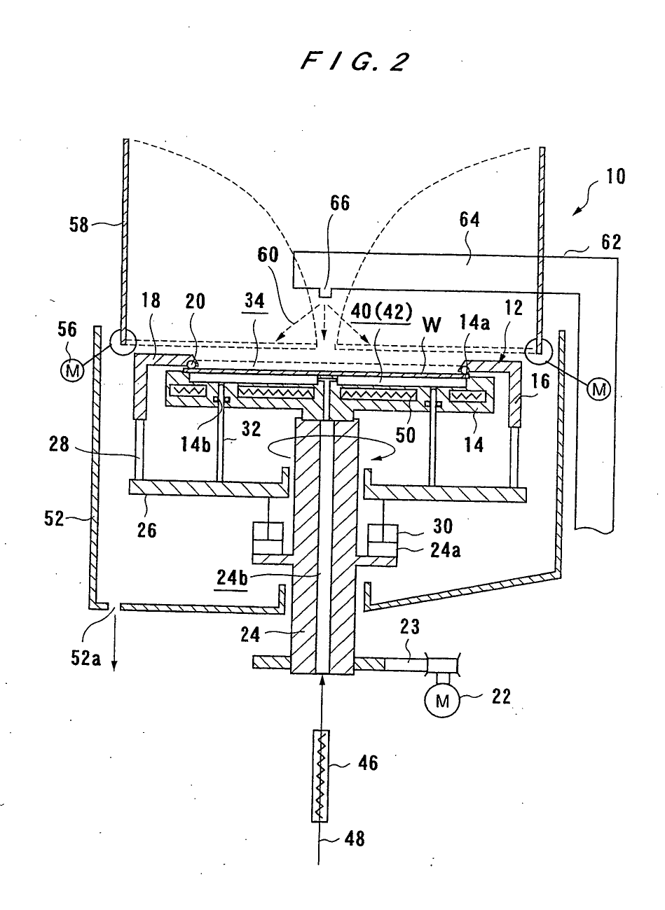

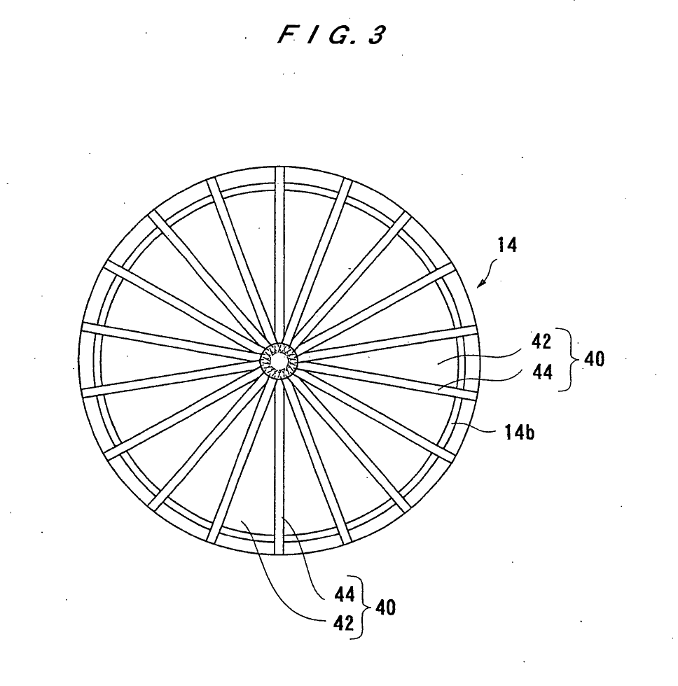

FIGS. 2 and 3 show an electroless plating device according to an embodiment of the present invention. The electroless plating device 10 can be used, for example, for the formation of the barrier layer 5 of FIG. 1, the reinforcement of the copper seed layer 6 and the deposition of the copper film 7, and also for the formation of the protective layer (plated film) 9.

The electroless plating device 10 includes a substrate holder 12 for holding a substrate (to-be-processed material) W, such as a semiconductor wafer, with its front surface (to-be-plated surface) upward. The substrate holder 12 is composed mainly of a treatment bath 14 having a heated fluid holding portion 40 that holds a heated fluid for heating the substrate W, as described below, and of a substrate pressing portion 16 that surrounds the treatment bath 14. To the substrate pressing portion 16 is integrally formed an extending portion 18 that extends to above the treatment bath 14. To an inner peripheral portion of the lower surface of the extending portion 18 is mounted a seal ring 20 that protrudes downwardly.

The treatment bath 14 is connected to the upper end of a main shaft 24 that rotates, via a belt 23, by the actuation of a motor 22, and is provided at the upper surface with a step 14a conforming to the size of the substrate W. The substrate pressing portion 16, on the other hand, is connected to the upper ends of rods 28 which are mounted vertically on a peripheral portion of a base 26 that surrounds the main shaft 24. Cylinders 30 are provided between the base 26 and a flange 24a that are fixed to the main shaft 24. By the actuation of the cylinders 30, the substrate pressing portion 16 moves up and down relative to the treatment bath 14. Thrusting-up pins 32, which protrude upwardly and reach to below the extending portion 18 of the substrate pressing portion 16, are mounted on the upper surface of the base 26, and through-holes 14b, which vertically penetrate the treatment bath 14, are provided opposite to the thrusting-up pins 32.

When the substrate pressing portion 16 is in a raised position relative to the treatment bath 14, a substrate W is inserted into the substrate pressing portion 16, and placed and held on the upper ends of the thrusting-up pins 32. The substrate pressing portion 16 is then lowered relative to the treatment bath 14 so as to place the substrate W within the step 14a of the upper surface of the treatment bath 14, and is further lowered so as to bring the seal ring 20 into pressure contact with a peripheral portion of the upper surface of the substrate W to thereby seal the peripheral portion and hold the substrate W, whereby a plating bath 34 is formed which is surrounded by the upper surface of the substrate W and by the seal ring 20, and which is opened upward. Release of the holding of the substrate W can be made by the reverse operation. With the substrate W kept held by the substrate holder 12, the treatment bath 14 and the substrate pressing portion 16 can rotate together by the actuation of the motor 22.

In the upper surface of the treatment bath 14, there is provided a heated fluid holding portion 40 for holding a heated fluid, e.g. a heated water, alcohol or organic solution, and allowing the heated fluid to contact the back surface of the substrate W held by the substrate holder 12 to heat the substrate W. As shown in FIG. 3, the heated fluid holding portion 40 includes a recess 42 which extends from the step 14a inwardly and is in a circular configuration conforming to the shape of the substrate W, and a plurality of fluid flow channels 44 which are deeper than the recess 42 and extend radially. The fluid flow channels 44 have the same depth and reach to the periphery of the treatment bath 14. Each fluid flow channel 44 communicates with a fluid passage 24b formed within the main shaft 24, and the fluid passage 24b in turn is connected to a fluid supply pipe 48 which, when a heated pure water, for example, is employed as a heated fluid, extends from a pure water supply source and has on its way a pure water heating section 46 for heating pure water up to the same temperature as the plating temperature, e.g. 60° C.

A heated fluid (hot water), which has been supplied from the pure water supply source and heated in the pure water heating section 46, passes through the fluid passage 24b and flows into the heated fluid holding portion 40, where the heated fluid flows mainly through the fluid flow channels 44 and flows out of the treatment bath 14.

The heated fluid, which has thus flowed into the heated liquid holding portion 40, comes into contact with the back surface of the substrate W held by the holder 12, thereby heating the substrate W. The heated fluid well follows the irregularities of the back surface of the substrate W and contacts the entire surface, enabling an efficient heat transfer to the substrate W with an increased contact area. Further, by utilizing as a heat source a heated fluid having a high heat capacity, such as a hot water, the substrate W can be heated more uniformly in a short time. For example, by bringing a hot water controlled at 60° C. into contact with the back surface of a semiconductor wafer, the semiconductor wafer can be heated so that the surface temperature reaches 60° C. in about 2-3 seconds. Moreover, the substrate W is not wholly immersed in a plating solution, leading to an easier management of the plating solution.

Further according to this embodiment, the treatment bath 14 has a built-in heater 50, and the heater 50 heats the heated fluid flowing within the heated fluid holding portion 40 so as to prevent the temperature of the heated fluid from being gradually lowered.

A scattering-proof cover 52 for preventing scattering of the heated fluid, and collecting the heated fluid and discharging it from the drain 52a is provided around the substrate pressing portion 16. Further, positioned above the scattering-proof cover 52, a pair of cover bodies 58 is disposed which can open and close by motors 56 and which covers the surface of the substrate W held by the substrate holder 12 to thereby create a nearly hermetic space. The cover body 58 may be composed of a single plate.

By closing the cover bodies 58 during plating to make the substrate W positioned within the nearly hermetic space, heat radiation from the substrate W can be prevented by the cover bodies 58 and the substrate W can be kept at a more uniform temperature during plating. When moving up and down the substrate W held by the substrate holder 12, the cover bodies 58 are opened to prevent the cover bodies 58 from impeding the substrate holder 12.

Further, positioned above the substrate holder 12, there is provided a plating solution supply section 62 for supplying a plating solution (electroless plating solution) 60 heated to a predetermined temperature, e.g. 60° C., into the plating bath 34 formed by the upper surface of the substrate W and the seal ring 20. The plating solution supply section 62 has a pivotable arm 64, and the pivotable arm 64 has at its end a jet nozzle 66 which jets the plating solution 60 uniformly onto the surface of the substrate W held by the substrate holder 12. The temperature of the plating solution is generally 25 to 90° C., preferably 55 to 85° C., more preferably 60 to 80° C.

Further, though not figured, a vertically-movable, pivotable plating solution recovering nozzle for sucking and recovering the plating solution in the plating bath 34, and a cleaning nozzle for supplying a cleaning liquid, such as ultrapure water, to the surface of the substrate W after the plating are provided above the substrate holder 12.

According to the electroless plating device 10 of this embodiment, a substrate W is inserted into the substrate pressing portion 16 when the substrate pressing portion 16 is in a raised position relative to the treatment bath 14, and the substrate W is placed and held on the thrusting-up pins 62. At this time, the cover bodies 58 are in the opened position. On the other hand, a heated fluid, such as a hot water, heated to the same temperature as the plating solution 60, e.g. 60° C., is introduced into the heated fluid holding portion 40 of the treatment bath 14, and the heated fluid is allowed to pass through the fluid flow channels 44 and overflow the treatment bath 14.

The substrate pressing portion 16 is then lowered relative to the treatment bath 14 so as to place the substrate W within the step 14a of the upper surface of the plating bath 14, and is further lowered so as to bring the seal ring 20 into pressure contact with a peripheral portion of the upper surface of the substrate W to thereby seal the peripheral portion and hold the substrate W, whereby the plating bath 34, opened upward and surrounded by the upper surface of the substrate W and by the seal ring 20, is formed. At the same time, the back surface of the substrate W is brought into contact with the heated fluid which has been introduced into the heated fluid holding portion 40 of the treatment bath 14.

When the substrate W is heated by the heated fluid to reach the same temperature as the heated fluid, e.g. 60° C., the plating solution 60 heated to a predetermined temperature, e.g. 60° C., is poured in a predetermined amount (e.g. about 100 to 200 cc for a semiconductor wafer with a diameter of 200 mm) from the jet nozzle 66 of the plating solution supply section 62 into the plating bath 34 surrounded by the upper surface of the substrate W and by the seal ring 20. The timing of the heated fluid supply can be adjusted according to the timing of the plating solution pouring. This can prevent the drying of the surface of the substrate, which may occur when a substrate is heated on a hot plate heater before a plating solution is poured onto the substrate W.

Thereafter, the cover bodies 58 are closed to prevent heat radiation from the surface of the substrate W. Further, according to necessity, the heated fluid that has been introduced into the heated fluid holding portion 40 is heated by the heater 50 so as to prevent the temperature of the heated fluid from being lowered during plating. The substrate W can thus be maintained at the temperature of the heated fluid over the entire surface during plating, whereby a plated film having a uniform thickness is allowed to grow. Moreover, since the peripheral portion of the substrate W is also kept immersed in the heated fluid, the temperature of the peripheral portion also is not lowered. During the plating, it is possible to rotate the substrate W so as to make the density of hydrogen gas and the concentration of dissolved oxygen uniform over the surface to be plated.

After completion of the plating treatment, the introduction of the heated fluid into the heated fluid holding portion 40 is stopped and the heated fluid is discharged from the introduction side, and the plating solution in the plating bath 34, surrounded by the seal ring 20 and the upper surface of the substrate W, is removed e.g. by suction. Thereafter, while rotating the substrate W, a cleaning liquid is jetted from the cleaning nozzle (not shown) toward the plated surface of the substrate W to cool the plated surface and, at the same time, dilute and clean the plated surface, thereby terminating the electroless plating reaction.

Thereafter, the substrate pressing portion 66 is raised relative to the treatment bath 14 and the substrate W is thrust up by the thrusting-up pins 32, and the substrate after the plating is then transferred e.g. by a hand of a robot to the next process step.

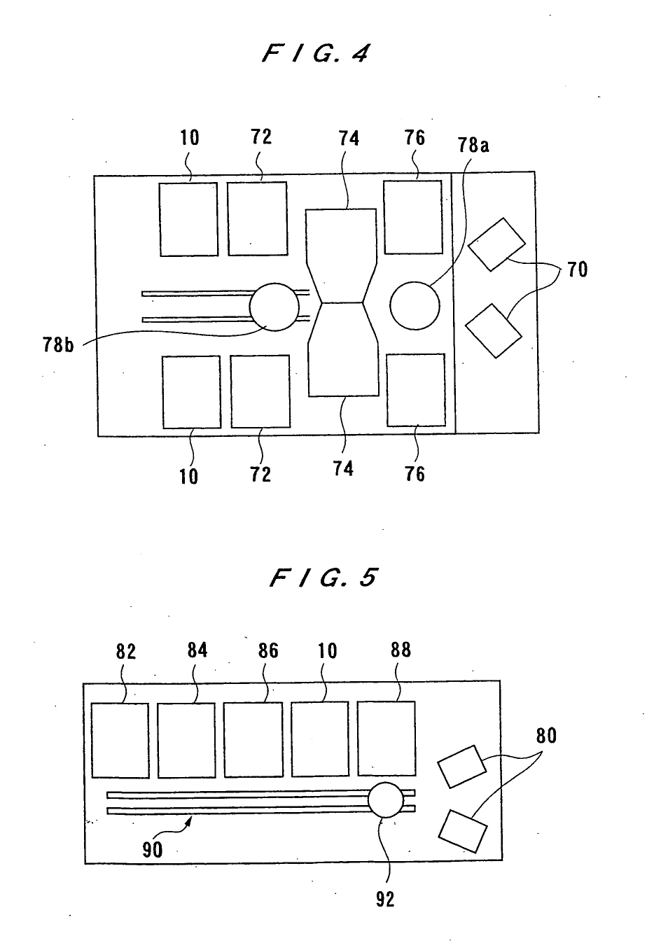

FIG. 4 shows the general construction of a plating treatment apparatus which is provided with the electroless plating device 10 and carries out a series of plating treatments. The plating treatment apparatus includes pairs of electroless plating devices 10, loading/unloading sections 70, pre-plating treatment devices 72 for carrying out a pre-plating treatment, such as a catalyst-imparting treatment to impart e.g. a Pd catalyst to a surface of a substrate or an oxide film-removing treatment to remove an oxide film adhering to the exposed surface of interconnects, temporary storage sections 74 capable of carrying out a rough cleaning, and post-cleaning devices 76. The plating treatment apparatus is also provided with a first transfer device 78a for transferring a substrate W between the loading/unloading sections 70, the post-cleaning devices 76 and the temporary storage sections 74, and a second transfer device 78b for transferring the substrate W between the electroless plating devices 10, the pre-plating treatment devices 72 and the temporary storage sections 74.

A description will now be given of a series of plating treatment process steps performed by the above plating treatment apparatus. First, a substrate W held in the loading/unloading section 70 is taken out by the first transfer device 78a, and the substrate is placed in the temporary storage section 74. The second transfer device 78b transfers the substrate W to the pre-plating treatment device 72, where the substrate is subjected to a pre-plating treatment, such as a catalyst-imparting treatment using a PdCl₂ solution or an oxide film-removing treatment for removing an oxide film adhering to the exposed surface of interconnects, and the treated substrate W is then rinsed.

Thereafter, the second transfer device 78b transfers the substrate W to the electroless plating device 10, where an electroless plating treatment is carried out using a predetermined plating solution having a predetermined reducing agent. Next, the second transfer device 78b takes the plated substrate out of the electroless plating device 10 and carries the substrate to the temporary storage section 74. Rough cleaning of the substrate is carried out in the temporary storage section 74. Thereafter, the first transfer device 78 carries the substrate to the post-cleaning device 76, where a finish cleaning e. g. by a pencil sponge and spin-drying of the substrate are carried out. After the cleaning, the first transfer robot 78a returns the substrate to the loading/unloading section 70. The substrate is later sent to a plating apparatus or to an oxide film-forming apparatus.

FIG. 5 shows the general construction of a plating treatment apparatus which performs a series of plating treatments (cap plating treatments) for forming the protective layer 9 shown in FIG. 1D. The plating treatment apparatus includes a pair of loading/unloading sections 80, a pretreatment section 82, a Pd-imparting treatment section 84, a pre-plating treatment section 86, the electroless plating device 10 and a cleaning/drying treatment section 88. The plating treatment apparatus is also provided with a transfer device 92 which can move along a transfer route 90 and transfers a substrate between the sections and devices.

A series of plating treatment (cap plating treatment) process steps as performed by this plating treatment apparatus will now be described. First, a substrate W held in the loading/unloading section 80 is taken out by the transfer device 92 and transferred to the pretreatment section 82, where a treatment of the substrate, e.g. re-cleaning of the surface of the substrate, is carried out. The cleaned substrate is transferred to the Pd-imparting treatment section 84, where Pd is adhered to the surface of copper film 7 (see FIG. 1C) to activate the exposed surface of copper film 7. Thereafter, the substrate is transferred to the pre-plating treatment section 86, where a pre-plating treatment, such as a neutralization treatment, is carried out to the substrate. Next, the substrate is transferred to the electroless plating device 10, where a selective electroless plating e.g. of a Co—W—P alloy is carried out onto the activated surface of copper film 7, thereby forming a Co—W—P film (protective layer) 9 on the exposed surface of copper film 7 to protect the exposed surface, as shown in FIG. 1D. A plating solution containing a cobalt salt and a tungsten salt and, as additives, a reducing agent, a complexing agent, a pH buffer and a pH adjusting agent, for example, may be used as an electroless plating solution in the electroless plating.

Alternatively, an electroless Ni—B plating may be carried out onto the exposed surface (after polishing) of the substrate to selectively form a protective layer (plated film) 9 composed of a Ni—B alloy film on the exposed surface of interconnects 8 to protect the interconnects 8. The thickness of the protective layer 9 is generally 0.1 to 500 nm, preferably 1 to 200 nm, more preferably 10 to 100 nm.

As an electroless Ni—B plating solution for forming the protection layer 9, use may be made of a solution which contains nickel ions, a complexing agent for nickel ions and an alkylamine borane or a borohydride compound as a reducing agent for nickel ions, and which is adjusted to a pH of 5-12 by using TMAH (tetramethylammonium hydroxide).

Next, the substrate W after the cap plating treatment is transferred to the cleaning/drying treatment section 88 to carry out a cleaning/drying treatment of the substrate, and the cleaned substrate W is returned by the transfer device 92 to a cassette in the loading/unloading section 80.

Though this embodiment shows, as a cap plating treatment, the case of previously activating the exposed surface of copper film 7 by adhering Pd thereto, and then carrying out an electroless Co—W—P plating to selectively cover the activated copper surface with a Co—W—P alloy film, the present invention, of course, is not limited to such an embodiment.

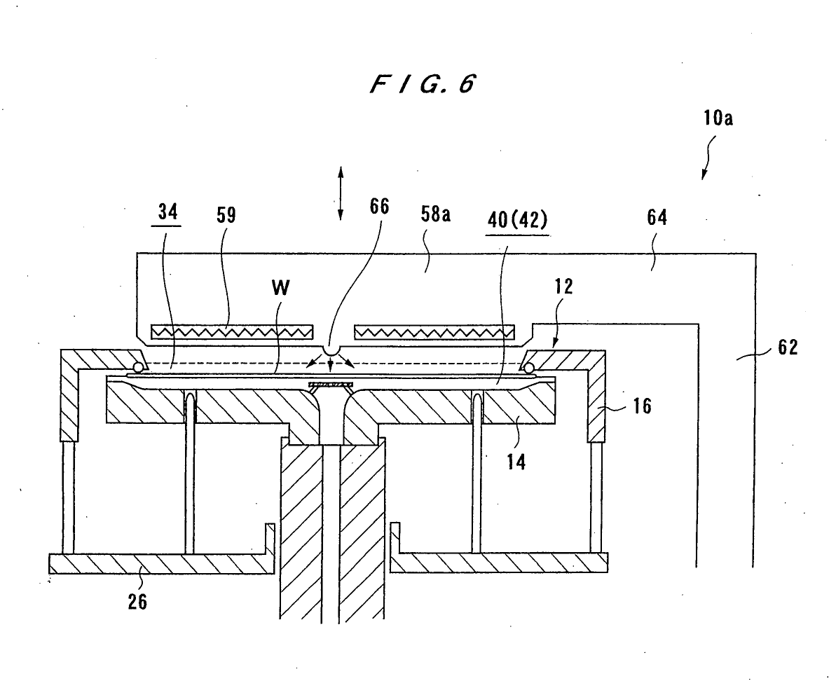

FIG. 6 shows an electroless plating device according to another embodiment of the present invention. This electroless plating device 10a includes a disk-shaped cover body 58a which can open and close, and move vertically and which covers the surface of the substrate W held by the substrate holder 12. The cover body 58a is integrated with the plating solution supply section 62. Further, the cover body 58a has a built-in heater 59 for keeping the heat-retaining space, which is surrounded by the substrate W and the cover body 58a, at a temperature near the temperature of a plating solution. The other construction is the same as shown in FIGS. 2 and 3. According to this embodiment, heat radiation from the surface of the plating solution, which has been supplied onto the surface, to be plated, of the substrate W, can be suppressed. It is also possible to provide the built-in heater 50 in the treatment bath 14, and heat the substrate from above and below.

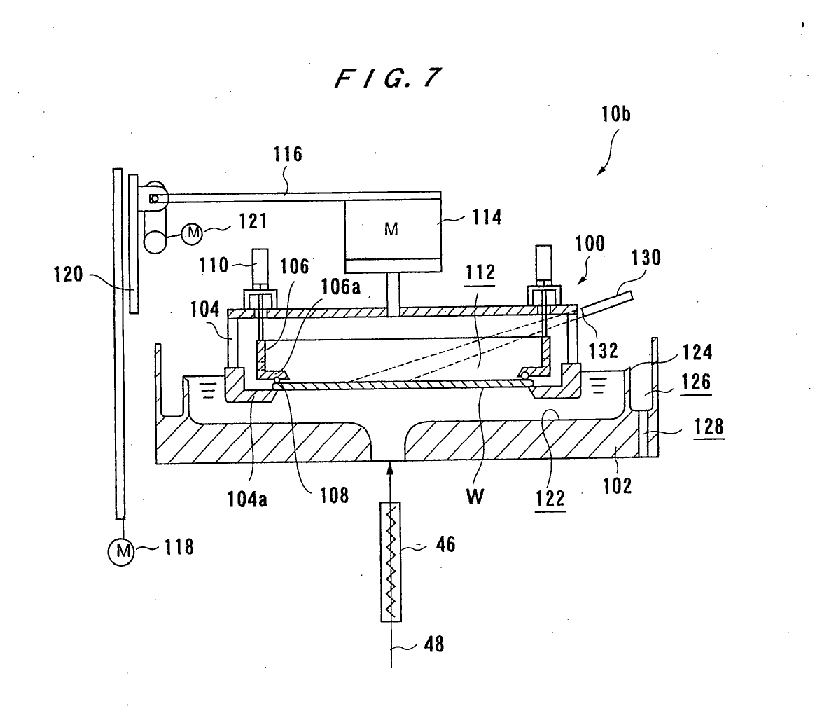

FIG. 7 shows an electroless plating device according to still another embodiment of the present invention. This electroless plating device 10b comprises a substrate holder 100 for holding a substrate (to-be-processed material) W with its front surface (to-be-plated surface) upward, and a treatment bath 102 provided below the substrate holder 100. The substrate holder 100 includes a housing 104 having at its lower end an inwardly-protruding holding nail 104a for placing thereon and holding a peripheral portion of the substrate W, and a substrate pressing portion 106 having at its lower end an inwardly-protruding seal nail 106a. A seal ring 108, protruding downwardly, is mounted on the lower surface of the seal nail 106a. The substrate pressing portion 106 is positioned inside the housing 104, and can move up and down relative to the housing 104 by the actuation of the cylinders 110 mounted on the housing 104.

When the substrate pressing portion 106 is in a raised position relative to the housing 104, a substrate W is inserted into the housing 104, and placed on the holding nail 104a. Thereafter, the substrate pressing portion 106 is lowered relative to the housing 104 so as to bring the seal ring 108 into pressure contact with a peripheral portion of the upper surface of the substrate W to thereby seal the peripheral portion and hold the substrate W, whereby a plating bath 112 is formed which is surrounded by the upper surface of the substrate W and by the substrate pressing portion 106, and which is opened upward. Release of the holding of the substrate W can be made by the adverse operation.

The substrate holder 100 is connected, via the housing 104, to a motor 114, and the motor 114 is fixed to the free end of an arm 116. The arm 116 is connected to a vertically-movable plate 120 that moves up and down by the actuation of a motor 118. Further, the arm 116 is allowed to tilt along the vertical plane by the actuation of a motor 121 for tilting. Accordingly, the substrate holder 100 is rotatable, vertically movable and tiltable, and can make a combined movement.

The treatment bath 102 is provided in its upper surface with a heated fluid holding portion 122 which is in the form of a concave having an inner diameter larger than the substrate W and which holds a heated fluid such as a hot water to heat the substrate W. The heated fluid holding portion 122 is surrounded by an overflow weir 124, and a heated fluid discharge channel 126 is provided outside the overflow weir 124. The heated fluid discharge channel 126 is provided with a drain 128. The heated fluid holding portion 122 is connected to the heated fluid supply pipe 48 which, when a heated pure water, for example, is employed as a heated fluid, extends from a pure water supply source and has on its way a pure water heating section 46 for heating pure water up to the same temperature as the plating temperature, e.g. 60° C.

The heated fluid (hot water), which has been supplied from the pure water supply source and heated in the pure water heating section 46, flows into the heated fluid holding portion 122, and the heated fluid flows out of the treatment bath 102 by overflowing the overflow weir 124.

Further, beside the substrate holder 100 is provided a plating solution supply section 130 for supplying a plating solution (electroless plating solution) 60 heated to a predetermined temperature, e.g. 60° C., into the plating bath 112 formed by the upper surface of the substrate W and the substrate pressing portion 106. The plating solution supply section 130 has at its front end a jet nozzle 132 for jetting the plating solution.

According to this embodiment, the substrate holder 100 holding the substrate W in the above-described manner is lowered to bring the back surface of the substrate W into contact with the heated fluid held in the heated fluid holding portion 122, thereby heating the substrate W. When the temperature of the substrate W reaches the plating temperature, the plating solution at a predetermined temperature is poured from the plating liquid supply section 130 into the plating bath 112 formed by the upper surface of the substrate W and by the substrate pressing portion 106 to carry out electroless plating.

Further according to this embodiment, the substrate W held by the substrate holder 100 is in a tilted position relative to the surface of the heated fluid when the back surface of the substrate W is brought into contact with the heated fluid, and the substrate W is then returned to a horizontal position. This can prevent air bubbles from remaining on the back surface of the substrate W. The substrate W may again be tilted after completion of the plating so as to gather up the electroless plating solution on the plated surface of the substrate W, facilitating discharge of the plating solution.

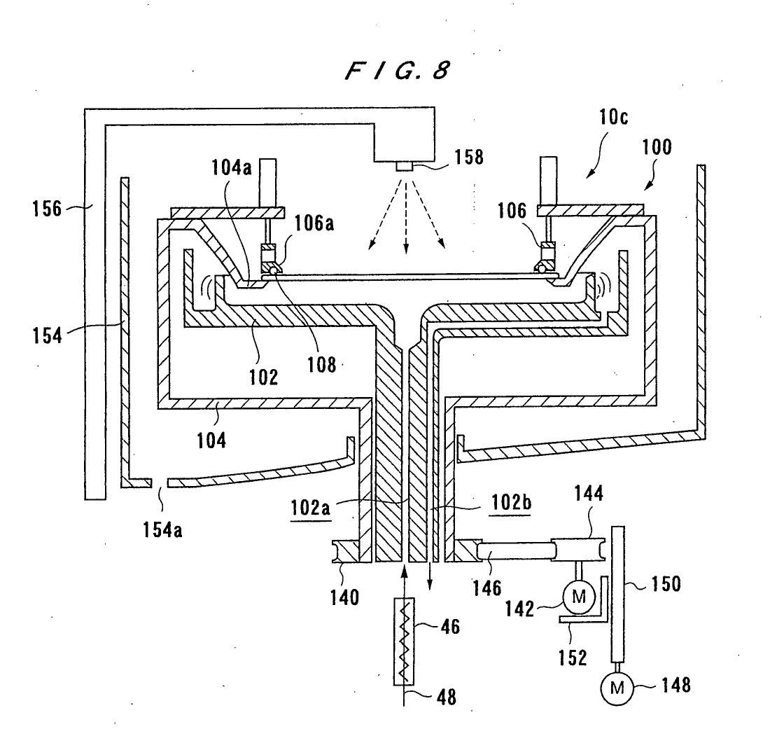

FIG. 8 shows an electroless plating device according to still another embodiment of the present invention. This electroless plating device 10c differs from the above-described electroless plating device 10b of FIG. 7 in the following respects: The housing 104 is extended downwardly; and a belt 146 is stretched between a driven roller 140 mounted on the downwardly-extending portion of the housing 104 and a driving roller 144 mounted on a motor 142. The motor 142 is fixed on a flange 152 which is mounted on a vertically-movable plate 150 that moves vertically by a motor 148. This enables the substrate holder 100 to rotate and move vertically.

Further, a heated fluid supply passage 102a and a heated fluid discharge passage 102b are formed inside the treatment bath 102, and the treatment bath 102 is surrounded by a scattering-proof cover 154 having a drain 154a for plating solution discharge. Moreover, a plating solution supply section 156 extends vertically beside the scattering-proof cover 154, bends at a right angle and reaches to right above the center of the substrate holder 100. A jet nozzle 158 facing downwardly is mounted to the end of the plating solution supply section 156, and the jet nozzle 158 jets a plating solution toward the upper surface (to-be-plated surface) of the substrate W. The other construction of the plating device 10c is the same as shown in FIG. 7.

According to this embodiment, the rotation and vertical-movement mechanism for the substrate holder 100 is provided below the housing 104, making the substrate holder 100 opened upward. This makes it possible to dispose the plating solution supply section 156 above the substrate holder 100, facilitating supply of the plating solution.

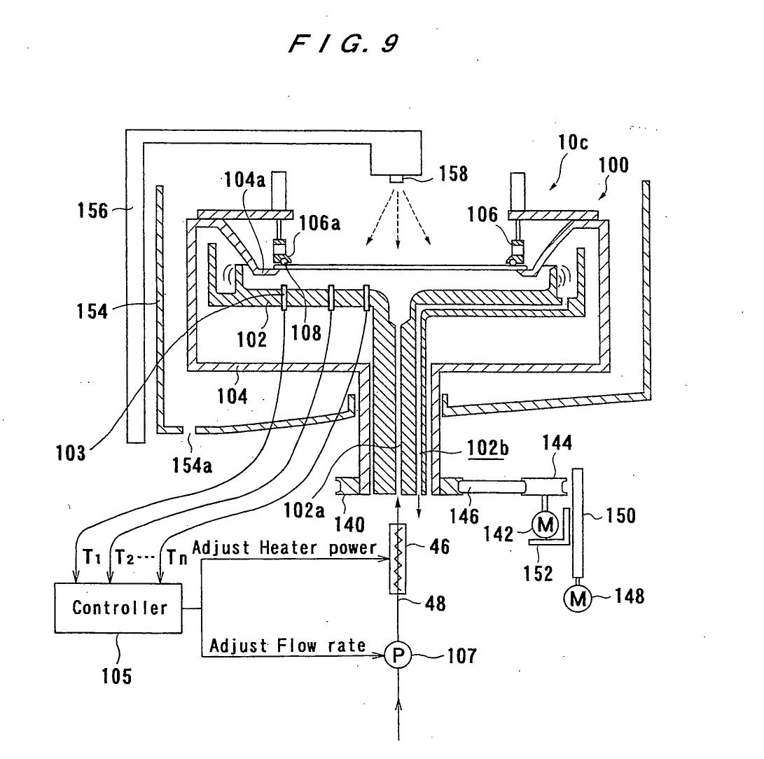

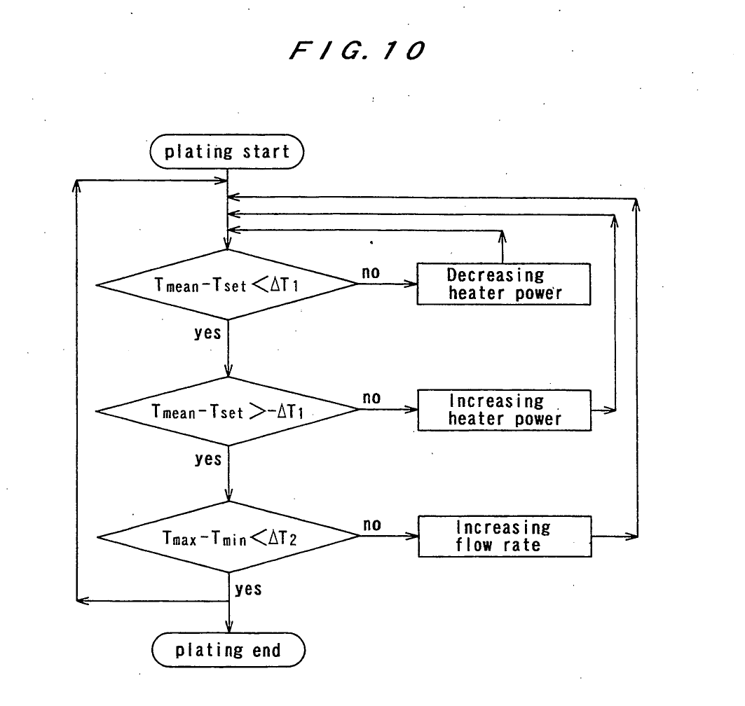

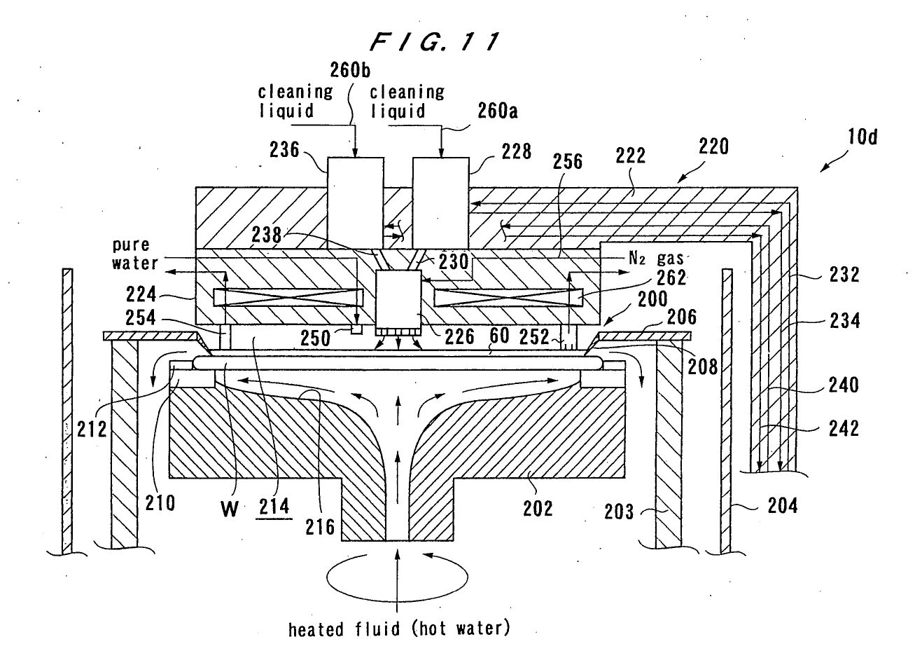

FIG. 9 shows a modification of the electroless plating device shown in FIG. 8. This electroless plating device 10c has temperature sensors 103 for detecting the temperature of the fluid in the heated fluid holding portion, and a controller 105 for controlling the power of a heater in the pure water heating section 46 and the flow rate of the fluid to be supplied by a pump 107. The temperature sensors 103 are disposed at a plurality of positions in the treatment bath 102, which correspond to positions within the surface of the substrate. Thus, the temperatures T₁, T₂, . . . , Tₙ of the fluid at desired positions can be detected by the temperature sensors 103. The controller 105 controls the power of the heater and the flow rate of the fluid based on the temperatures T₁, T₂, . . . , Tₙ detected by the temperature sensors 103.

FIG. 10 is a flow chart of the process in the controller 105. In FIG. 10, Tₘₑₐₙ represents the average of the temperatures detected by the temperature sensors 103, Tₘₐₓ a maximum value of the detected temperatures, Tₘᵢₙ a minimum value of the detected temperatures, Tₛₑₜ a set point of the temperature of the fluid, ΔT₁ a tolerance of a difference between the average Tₘₑₐₙ and the set point Tₛₑₜ, and ΔT₂ a tolerance of variations within the surface of the substrate (i.e., a tolerance of a difference between the maximum value Tₘₐₓ and the minimum value Tₘᵢₙ). In many cases, the quality of the substrates depends upon the uniformity within the surface of the substrate rather than the processing temperature, in the plating process. Therefore, the tolerance ΔT₂ is generally set to be smaller than the tolerance ΔT₁.

When the plating process is started, it is determined whether or not the difference (=Tₘₑₐₙ−Tₛₑₜ) between the average Tₘₑₐₙ and the set point Tₛₑₜ is smaller than the tolerance ΔT₁. If the difference is larger than the tolerance ΔT₁, then the power of the heater in the pure water heating section 46 is decreased because the temperature of the fluid is higher than the tolerant level. If the difference is smaller than the tolerance ΔT₁, then it is determined whether or not the difference (=Tₘₑₐₙ−Tₛₑₜ) between the average Tₘₑₐₙ and the set point Tₛₑₜ is larger than −ΔT₁. If the difference is smaller than −ΔT₁, then the power of the heater in the pure water heating section 46 is increased because the temperature of the fluid is lower than the tolerant level. If the difference is larger than −ΔT₁, then the uniformity within the surface of the substrate is inspected. Specifically, it is determined whether or not the difference (=Tₘₐₓ−Tₘᵢₙ) between the maximum value Tₘₐₓ and the minimum value Tₘᵢₙ is smaller than the tolerance ΔT₂. If the difference is larger than the tolerance ΔT₂, then the flow rate of the fluid is increased because the fluid has large variations in temperature. If the difference is smaller than the tolerance ΔT₂, then the plating process is continued in the present state because the temperatures of the fluid are uniformly maintained within the surface of the substrate.

With the above control process, it is possible to constantly supply a fluid having a suitable temperature to the back surface of the substrate, for thereby plating the substrate at a desired temperature.

In the present embodiment, the temperature sensors are provided at a fixed portion of the plating device. However, the temperature sensors may be provided at a rotatable portion with use of a rotary connector.

The above control process is applicable not only to a plating device, but also to other fluid processing devices in which the temperature is importantly controlled.

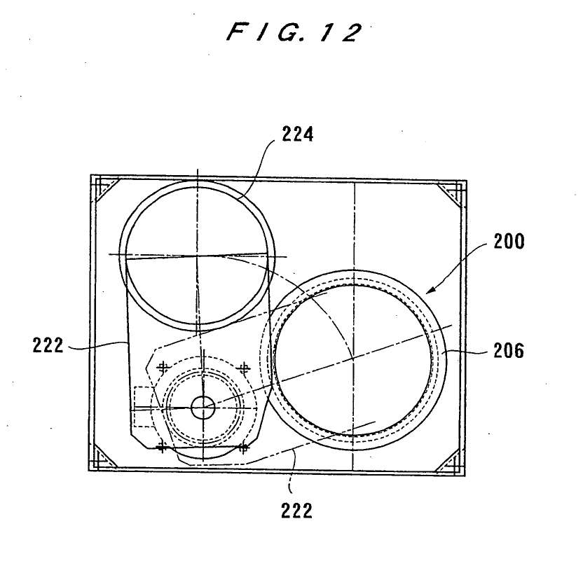

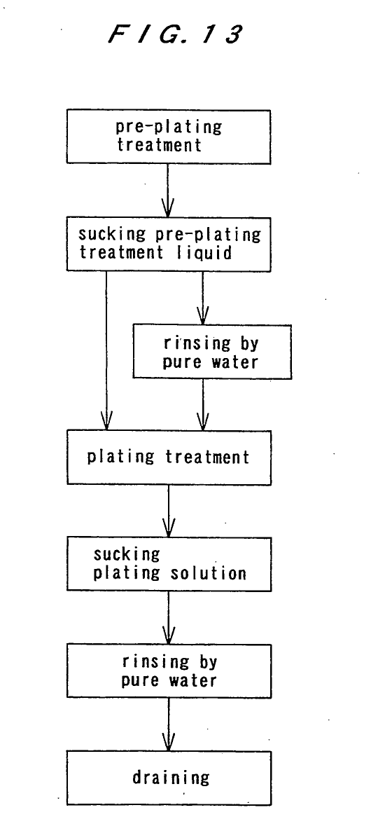

FIGS. 11 and 12 show an electroless plating device according to still another embodiment of the present invention. This electroless plating device 10d includes a substrate holder 200 for holding a substrate (to-be-processed material) W with its front surface (to-be-plated surface) upward. The substrate holder 200 is composed mainly of a treatment bath 202 having a heated fluid holding portion 216 that holds a heated fluid for heating the substrate W, as described below, and a cylindrical housing 203 that surrounds the treatment bath 202. A hollow, disk-shaped support plate 206 is fixed on the upper end of the housing 203, and a seal ring 208, protruding downwardly, is mounted on the inner circumferential surface of the support plate 206.

A ring-shaped substrate stage 210 for supporting a peripheral portion of the substrate W and a guide ring 212, which is positioned at the periphery of the substrate W and prevents misalignment of the substrate W, are mounted on the upper surface of the treatment bath 202. The treatment bath 202 can move up and down relative to the housing 203. A substrate W is inserted into the housing 203 when the treatment bath 202 is in a lowered position relative to the housing 203, and the substrate W is placed and held on the upper surface of the substrate stage 210. Thereafter, the treatment bath 202 is raised relative to the housing 203 so as to bring the seal ring 208 into pressure contact with a peripheral portion of the upper surface of the substrate W to thereby seal the peripheral portion and hold the substrate W, whereby a plating bath 214 is formed which is surrounded by the upper surface of the substrate W and by the seal ring 208, and which is opened upward. Release of the holding of the substrate W can be made by the adverse operation. With the substrate W kept held by the substrate holder 200, the treatment bath 202 and the housing 203 can rotate together by the actuation of a motor (not shown).

In the upper surface of the treatment bath 202, there is provided a heated fluid holding portion 216 for holding a heated fluid, e.g. a heated water, alcohol or organic solution, and allowing the heated fluid to contact the back surface of the substrate W to heat the substrate W. The heated fluid holding portion 216 is composed of a flow channel which is opened upward and in the shape of a bugle in section and, as in the above-described devices, is connected to a fluid supply pipe which has on its way e.g. a pure water heating section for heating pure water to e.g. 60° C. The heated fluid overflowing the heated fluid holding portion 216 passes between the treatment bath 202 and the housing 203 and flows out to the outside. Further, as in the above-described devices, a scattering-proof cover 204 for preventing scattering of the heated fluid is provided around the housing 203.

Positioned above the substrate holder 200, there is provided a plating solution supply section 220 for supplying a plating solution 60 (electroless plating solution) heated to a predetermined temperature, e.g. 60° C., into the plating bath 214 formed by the upper surface of the substrate W and the seal ring 208. The plating solution supply section 220 has a vertically-movable, pivotable pivot arm 222, and a disk-shaped head section 224, which almost covers the opening of the plating bath 214, is fixed to the free end of the pivot arm 222. By the pivoting of the pivot arm 222, as shown in FIG. 12, the head section 224 moves between the position covering the substrate holder 200 and the retreat position. Thus, the head section 224 is located in the position covering the upper surface of the substrate W held by the substrate holder 200 while the plating treatment is carried out, and is moved to the retreat position after the plating, thereby preventing the head section 224 from impeding transfer of the substrate W or the like.

In the substantially central portion of the head section 220, there are provided a downwardly-opened plating solution supply nozzle 226 and, positioned above the plating solution supply nozzle 226, a plating solution holding bath 228 having such volume that can hold a predetermined amount of plating solution necessary for one plating treatment. The plating solution supply nozzle 226 and the plating solution holding bath 228 are connected by a plating solution pipe 230 each other. A plating solution supply pipe 232 and a plating solution discharge pipe 234 are connected to the plating solution holding bath 228. Further, switching valves (not shown) are provided in the plating solution pipe 230, the plating solution supply pipe 232 and the plating solution discharge pipe 234.

In a non-plating time, the switching valve of the plating solution pipe 230 is kept closed, whereas the switching valves of the plating solution supply pipe 232 and of the plating solution discharge pipe 234 are kept opened, thereby circulating the plating solution contained in the plating solution holding bath 228 so as to constantly keep a predetermined amount of plating solution at a constant temperature within the plating solution holding bath 228. At the time of plating, the switching valve of the plating pipe 230 is opened, and the switching valves of the plating solution supply pipe 232 and of the plating solution discharge pipe 234 are closed, allowing the predetermined amount of plating solution at the constant temperature held in the plating solution holding bath 228 to be supplied, by its own weight, from the plating nozzle 226 into the plating bath 214, formed by the upper surface of the substrate W and the seal ring 208, in a moment of time (e.g. 1-5 seconds).

Positioned above the plating solution supply nozzle 226, there is also provided a pre-plating treatment liquid holding bath 236 for holding a pre-plating treatment liquid, such as a cleaning liquid for carrying out a pre-plating cleaning or a catalyst-imparting liquid for carrying out a catalyst-imparting treatment. The pre-plating treatment liquid holding bath 236 and the plating solution supply nozzle 226 are connected by a pre-plating treatment liquid pipe 238 each other. A pre-plating treatment liquid supply pipe 240 and a pre-plating treatment liquid discharge pipe 242 are connected to the pre-plating treatment liquid holding bath 236. Further, switching valves (not shown) are provided in the pre-plating treatment liquid pipe 238, the pre-plating treatment liquid supply pipe 240 and the pre-plating treatment liquid discharge pipe 242.

By the same valve operation as described above with reference to the plating solution, a predetermined amount of pre-plating treatment liquid at a constant temperature is kept in the pre-plating treatment holding bath 236 in a non-pretreatment time, and at the time of pre-plating treatment, the pre-plating treatment liquid held in the pre-plating treatment holding bath 236 is allowed to be supplied, by its own weight, from the plating solution supply nozzle 226 into the plating bath 214, formed by the upper surface of the substrate W and the seal ring 208, in a moment of time (e.g. 1-5 seconds).

Though in this embodiment the plating solution supply nozzle 226 is used also as a pre-plating treatment liquid supply nozzle, it is possible to separately provide such nozzles. In a case where a plurality of pre-plating treatments are carried out, it is, of course, possible to provide a plurality of pre-plating treatment liquid holding baths, and sequentially supply pre-plating treatments liquids held in the respective baths to the surface, to be plated, of a substrate W.

The above construction of the electroless plating device 10d makes it possible to carry out the pretreatment, such as cleaning or a catalyst-imparting treatment, and the plating treatment successively in the single bath onto the substrate W held by the substrate holder 200. H₂SO₄, HF, HCl, NH₃, DMAB (dimethylamine borane), oxalic acid, etc. may be used as a cleaning liquid for carrying out the pre-plating cleaning, and PdSO₄, PdCl₂, etc. may be used as a catalyst-imparting liquid for carrying out the catalyst-imparting treatment.

The head section 224 is provided with a pure water supply nozzle 250 for supplying pure water to the upper surface (plated surface) of the substrate W held by the substrate holder 200. By supplying pure water from the pure water supply nozzle 250 to the surface of the substrate after the plating treatment, the plating treatment of the substrate and rinsing of the plated substrate with pure water can be carried out successively in the single bath.

The head section 224 is also provided with a plating solution recovery nozzle 252 for recovering the plating solution which has been supplied to the surface, to be plated, of the substrate W held by the substrate holder 200, and a pre-plating treatment liquid recovery nozzle 254 for recovering the pre-plating treatment liquid which has been supplied to the surface, to be plated, of the substrate W held by the substrate holder 200. By recovering the plating solution by the plating solution recovery nozzle 252 and reusing the plating solution, and also recovering, according to necessity, the pre-plating treatment liquid by the pre-plating treatment liquid recovery nozzle 254 and reusing the liquid, the amount of the plating solution used and the amount of the pre-plating treatment liquid used can be reduced, whereby the running cost can be lowered.

An inert gas introduction line (inert gas introduction section) 256 for introducing a heated inert gas, e.g. N₂ gas, is connected to the plating solution supply nozzle 226. The heated inert gas introduced from the inert gas introducing line 256 into the plating solution supply nozzle 226, after purging the inside of the plating solution supply nozzle 226, is jetted toward the substrate W held by the substrate holder 200. Thus, the inert gas is introduced into the space between the substrate W held by the substrate holder 200 and the head section 224 which is in the position covering the upper surface of the substrate W, whereby the space is brought to the inert gas atmosphere at a predetermined temperature. This can effectively prevent air contacting the surface of the plating solution. In this regard, if air contacts the surface of the plating solution, oxygen in the air is taken in the plating solution to increase the amount of dissolved oxygen in the plating solution, which would restrain the oxidizing action based on a reducing agent, leading to poor deposition of the plating. Such a drawback can be obviated by bringing the above space to an inert gas atmosphere. Further, by keeping the space under the atmosphere of heated inert gas, the temperature of the plating solution can be prevented from being lowered during plating. The space surrounded by the head section 224 and by the substrate W may be brought to the atmosphere of inert gas at a predetermined temperature before supply of the plating solution to the substrate, whereby mixing of air into the plating solution and lowering of the solution temperature upon supply of the plating solution in air can be prevented. When the temperature of the plating solution is 70° C., for example, the temperature of the inert gas, such as N₂ gas, is generally 60 to 70° C. (temperature of plating solution −10° C. to temperature of plating solution), preferably 65 to 70° C. (temperature of plating solution −5° C. to temperature of plating solution).

A cleaning liquid introduction line (cleaning liquid introduction section) 260a is connected to the plating solution holding bath 228, and a cleaning liquid introduction line (cleaning liquid introduction section) 260b is connected to the pre-plating treatment liquid holding bath 236. A cleaning liquid from the cleaning liquid introduction line 260a flows through the plating solution holding bath 228, the plating solution pipe 230 and the plating solution nozzle 226 in this order; and a cleaning solution from the cleaning solution introduction line 260b flows through the pre-plating treatment liquid holding bath 236, the pre-plating treatment liquid pipe 238 and the plating solution supply nozzle 226 in this order. Extraneous matters adhering to the inner wall surfaces of these baths, pipes and nozzles can thus be cleaned off. The cleaning may be practiced periodically or at an arbitrary time. Pure water or a cleaning chemical, such as HNO₃, aqua regia or HF, may be used as the cleaning liquid.

According to this embodiment, the head section 224 has a built-in heater 262 for keeping the heat-retaining space between the substrate W held by the substrate holder 200 and the head section 224 nearly at the temperature of the plating solution.

The plating treatment performed by the electroless plating device 10d of this embodiment will now be described by referring to FIG. 13. First, a substrate W is inserted into the housing 203 when the treatment bath 202 is in a lowered position relative to the housing 203, and the substrate is placed and held on the substrate stage 210. At this time, the head section 224 is in the retreat position. The treatment bath 202 is then raised relative to the housing 203 so as to bring the seal ring 208 into pressure contact with a peripheral portion of the upper surface of the substrate W to thereby seal the peripheral portion and hold the substrate W, thereby forming the plating bath 214 which is opened upward and surrounded by the upper surface of the substrate W and the seal ring 208.

Next, the head section 224 is moved to the position right above the substrate holder 200, and is then lowered. Thereafter, a predetermined amount of pre-plating treatment liquid, such as a cleaning liquid or a catalyst-imparting liquid, held in the pre-plating treatment liquid holding bath 236 is supplied, by its own weight, from the plating solution supply nozzle 226, which is used also as a pre-plating treatment liquid supply nozzle, to the surface, to be plated, of the substrate W held by the substrate holder 200 in a moment of time, thereby carrying out pre-plating treatment. After completion of the pre-plating treatment, the pre-plating treatment liquid remaining on the surface, to be plated, of the substrate W is recovered by the pre-plating treatment liquid recovery nozzle 254, and is reused according to necessity.

Next, a heated fluid, such as a hot water, heated to the same temperature as the plating solution 60, e.g. 70° C., is introduced into the heated fluid holding portion 216 of the treatment bath 202, and the heated fluid is allowed to contact the back surface of the substrate W held by the substrate holder 200 and then overflow. When the substrate W is heated by the heated fluid to reach the same temperature as the heated fluid, e.g. 70° C., a predetermined amount of plating solution (e.g. about 100-200 cc for a wafer with 200 mm diameter, and about 200-400 cc for a wafer with 300 mm diameter) at a predetermined temperature, held in the plating solution holding bath 228, is supplied, by its own weight, from the plating solution supply nozzle 226 to the surface, to be plated, of the substrate held by the substrate holder 200 in a moment of time, thereby carrying out plating treatment.

Upon the electroless plating treatment, a heated inert gas is introduced from the inert gas introduction line 256 into the plating solution supply nozzle 226. The heated inert gas, after purging the inside of the plating solution supply nozzle 226, is introduced into the space between the substrate W held by the substrate holder 200 and the head section 224 in the position covering the upper surface of the substrate W so as to keep the space under the inert gas atmosphere at a predetermined temperature.

Further, as necessary, the plating solution is heated by the heater 262 to prevent lowering of the plating solution temperature during plating.

During the above plating treatment, the substrate W is maintained at the temperature of the heated fluid over the entire surface, whereby a plated film having a uniform film thickness is allowed to grow. Moreover, since the peripheral portion of the substrate W is also kept immersed in the heated fluid, the temperature of the peripheral portion also is not lowered. During the plating, it is possible to rotate the substrate W so as to make the release of hydrogen gas and the concentration of dissolved oxygen uniform over the surface to be plated.

After completion of the plating treatment, the introduction of the heated fluid into the heated fluid holding portion 216 is stopped and the heated fluid is discharged from the introduction side, and the plating solution in the plating bath 214, surrounded by the seal ring 208 and the upper surface of the substrate W, is recovered, e.g. by vacuum suction, from the plating solution recovery nozzle 252 and is reused according to necessity. Further, the introduction of the inert gas from the inert gas introduction line 256 is stopped. Thereafter, while rotating the substrate W, pure water is jetted from the pure water supply nozzle 250 toward the plated surface of the substrate W to cool the plated surface and, at the same time, dilute and clean the plated surface, thereby terminating the electroless plating reaction. The substrate W is then rotated at a high speed for draining.

Thereafter, the head section 224 is raised and retreated to the retreat position, and then the treatment bath 202 is lowered relative to the housing 203 to thereby release the holding of the substrate W. Thereafter, the plated substrate is transferred, e.g. by a hand of a robot, to the next process step.

According to the plating device 10d of this embodiment, a series of plating treatments, including pre-plating treatment, plating treatment, rinsing by pure water and cleaning, and draining, can be carried out successively in the single bath. Thus, the treatments can be carried out with the surface (to-be-plated surface) of the substrate W kept wet, i.e. drying of the surface being prevented. Further, the number of baths can be reduced, whereby the installation space can be made smaller.

As described hereinabove, the plating device of the present invention can prevent the temperature of a material, to be processed, from becoming uneven over the surface, to be plated, during plating and can also prevent change of the plating temperature during plating, making it possible to form a plated film having a more uniform film thickness on the surface, to be plated, of the material.

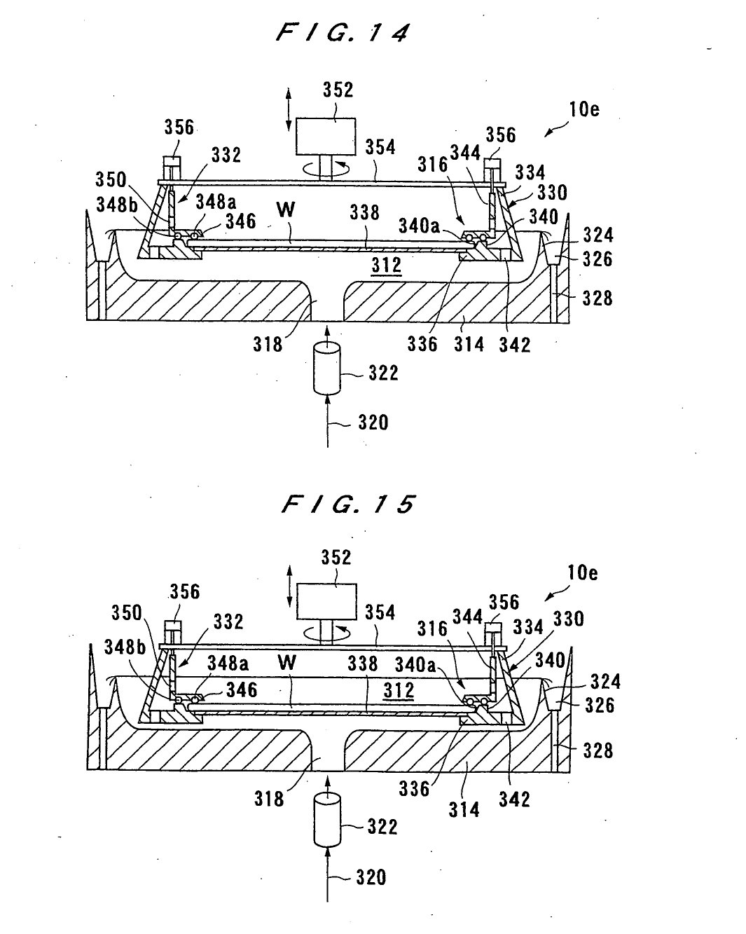

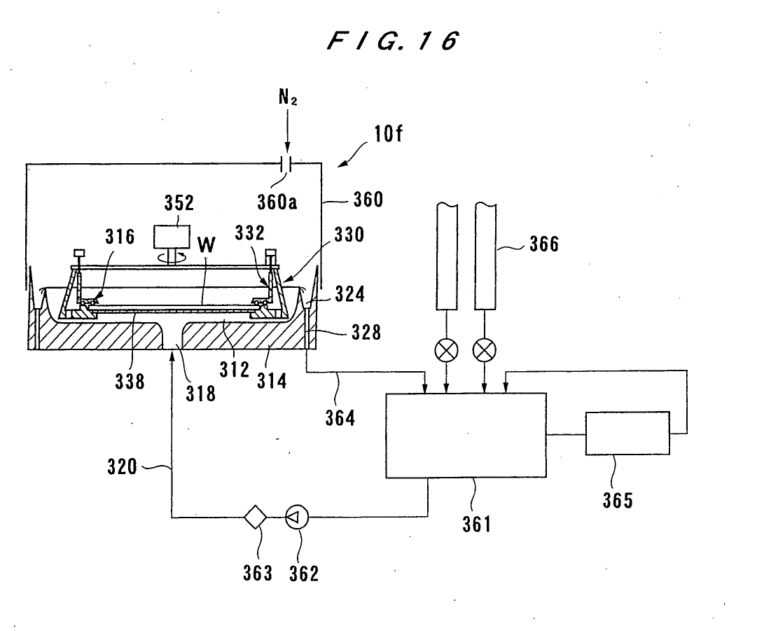

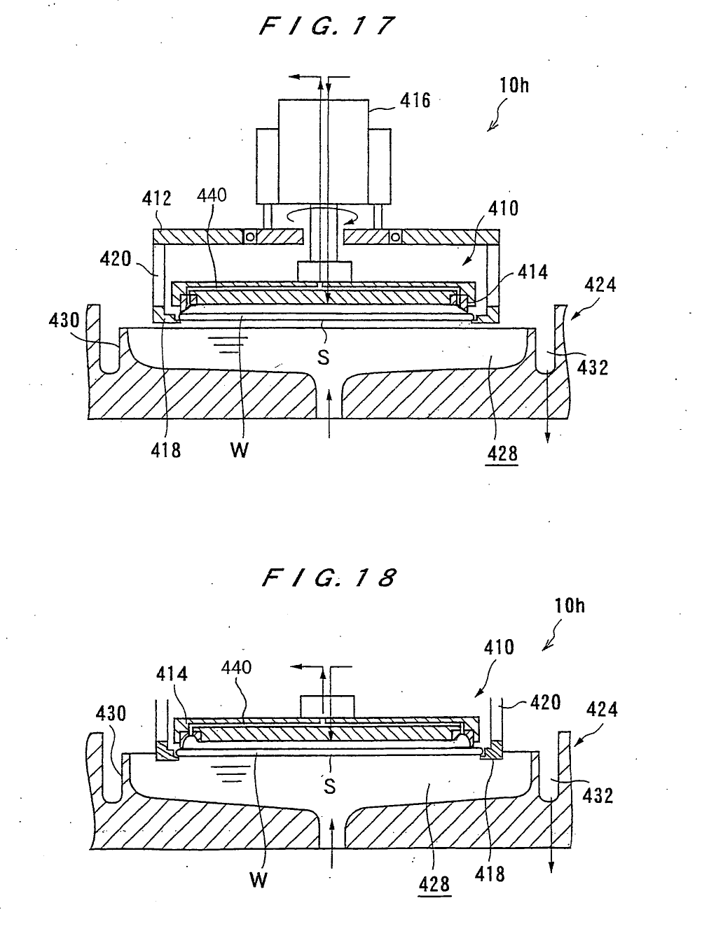

FIGS. 14 and 15 show an electroless plating device according to still another embodiment of the present invention. This electroless plating device 10e includes an upwardly-opened plating bath 314 that holds a plating solution 312, and a substrate holder 316, provided in the top opening of the plating bath 314, for holding a substrate (to-be-processed material) W, such as a semiconductor, with its front surface (to-be-plated surface) upward.

The plating bath 314 has, at the center of its bottom, a plating solution introduction inlet 318. The plating solution inlet 318 is connected to a plating solution supply pipe 320. The plating solution supply pipe 320 is provided with a heater 322 for heating the plating solution 312 passing through the supply pipe 320 to a predetermined temperature, e.g. 60° C. An overflow weir 324 is provided in the upper portion of the plating bath 314, and a plating solution discharge channel 326 is provided outside the overflow weir 324. The plating solution discharge channel 326 communicates with a plating solution discharge hole 328 vertically penetrating the plating bath 314.

The plating solution 312 is introduced through the plating solution introduction pipe 320 into the plating bath 314, and on its way is heated by the heater 322 to a predetermined temperature. When the amount of the plating solution 312 in the plating bath 314 reaches a certain level, the plating solution 312 overflows the overflow weir 324 into the plating solution discharge channel 326, and is discharged through the plating solution discharge hole 328 to the outside. The temperature of the plating solution 312 is generally 25 to 90° C., preferably 55 to 85° C., more preferably 60 to 80° C.

The substrate holder 316 is composed mainly of a substrate stage 330 and a substrate holding portion 332. The substrate stage 330 includes a substantially cylindrical housing 334 and a ring-shaped support frame 336 coupled to the lower end of the housing 334. In the inside of the frame 336, a heat conductor 338 in the form of a thin film is stretched by attaching its peripheral portion to the support frame 336. In the upper surface of the support frame 336 is formed a protruding portion 340 having in its inner surface a tapered surface 340a which, when introducing the substrate W to support it on the support frame 336, serves as a guide for the substrate W. The support frame 336 is so designed that its inner diameter is slightly smaller than the diameter of the substrate W to be supported by the support frame 336. The support frame 336 is also so designed that its upper surface on the inner side of the protruding portion 340 is on the same plane with the upper surface of the heat conductor 338. Further, through-holes 342, vertically penetrating the support frame 336, are formed at the outer side positions of the protruding portion 340.

The substrate holding portion 332, on the other hand, includes a cylindrical body 344 provided inside the housing 334 of the substrate stage 330, and a ring-shaped nail portion 346 coupled to the lower end of the cylindrical body 344 and extending inwardly. Ring-shaped seal materials 348a and 348b are concentrically mounted on the lower surface of the nail portion 346, respectively to the position corresponding to a peripheral portion of the substrate W as supported on the support frame 336 of the substrate stage 330 and to the position corresponding to the upper surface of the protruding portion 340. Further, communicating holes 350 that communicate with the inside and the outside of the cylindrical body 344 are formed at certain positions in the height direction of the cylindrical body 344.

There is also provided a disk-shaped support 354 that rotates and vertically moves by the actuation of a motor 352. The support 354, at its peripheral portion of the lower surface, is coupled to the housing 334 of the substrate stage 330. Further, cylinders 356 for vertically moving the substrate holding portion 332 are mounted on the support 354. Accordingly, by the actuation of the cylinders 356, the substrate holding portion 332 moves up and down relative to the substrate stage 330 and, by the actuation of the motor 352, the substrate holding portion 332 rotates and moves vertically together with the substrate stage 330.

According to the substrate holder 316, when the substrate holding portion 332 is in a raised position relative to the substrate stage 330, a substrate W is dropped onto the upper surface of the support frame 336 of the substrate stage 330 so that the substrate W is placed and supported on the support frame 336. The substrate holding portion 332 is then lowered relative to the substrate stage 330 so as to bring the seal materials 348a and 348b into pressure contact with the peripheral portion of the substrate W supported on the support 336 and with the upper surface of the protruding portion 340 of the support frame 336, respectively, to thereby seal the peripheral portion and the back surface of the substrate W and hold the substrate W. With the substrate W thus held by the substrate holder 316, the substrate holder 316 is allowed to rotate and move vertically by the motor 352.

When the substrate W is held by the substrate 316, the back surface of the substrate W is covered with the heat conductor 338, and the peripheral portion of the substrate W is sealed by the support frame 336 of the substrate stage 330 and by the seal materials 348a and 348b. Accordingly, when the substrate W held by the substrate holder 316 is immersed in the plating solution 312 in the plating bath 314, the back surface and the peripheral portion of the substrate W do not contact the plating solution, and thus are not plated.

The substrate W held by the substrate holder 316 is surrounded by the cylindrical body 344, and the communicating holes 350 are formed at a certain position in the height direction of the cylindrical body 344. Accordingly, when the substrate holder 316, with the substrate W held by it, is lowered, the plating solution 312 held in the plating bath 314 does not flow into the inner side of the cylindrical body 344, that is, does not flow onto the surface (upper surface), to be plated, of the substrate W until the surface of the plating solution 312 reaches the communicating holes 350, and when the plating solution 312 has reached the communicating holes 350, it begins to flow through the communicating holes 350 into the inner side of the cylindrical body 344 and the surface, to be plated, of the substrate W becomes immersed in the plating solution 312.

Before the plating solution 312 begins to flow through the communicating holes 350 into the inner side of the cylindrical body 344, the support frame 336 of the substrate stage 330 and the heat conductor 338 come into contact with the plating solution 312, whereby the substrate W held by the substrate holder 316 and the support frame 336 are heated (pre-heated) by the heat of the plating solution 312 itself. The use as the heat conductor 338 of a thin film enables the heat conductor 338 to follow the irregularities of the back surface of the substrate W, thereby increasing the contact area and enhancing the efficiency of heat transfer to the substrate W. Further, the use as a heat source of the fluid (plating solution) having a high heat capacity makes it possible to heat the substrate W more uniformly in a short time.

For an effective heating (pre-heating) of the substrate W, the substrate holder 316 is, according to necessity, temporally stopped at a pre-heating position as shown in FIG. 14, i.e. a position at which the lower surface of the substrate stage 330 is in contact with the plating solution 312 in the plating bath 314 and the surface of the plating solution 312 is below the communicating holes 350 formed in the cylindrical body 344. Thus, in the case where the substrate W and the substrate frame 336 cannot be sufficiently heated when the substrate holder 316 is lowered to the plating position shown in FIG. 15 without a stop, the substrate holder 316 is stopped at the pre-heating position so that the substrate W and the support frame 336 are heated by the heat of the plating solution 312 itself to reach a stable temperature, and after the stable temperature is reached, the substrate holder 316 is lowered to the plating position shown in FIG. 15.

According to the electroless plating device 10e of this embodiment, the plating solution 312 heated to a predetermined temperature, e.g. 60° C., is introduced into the plating bath 314 and is allowed to overflow the overflow weir 324. On the other hand, when the substrate holder 316 is in a raised position relative to the plating bath 314 and the substrate holding portion 332 is in a raised position relative to the substrate stage 330, the substrate W is inserted into the substrate stage 330, and placed and supported on the support frame 336. Thereafter, the substrate holding portion 332 is lowered so as to bring the sealing materials 348a and 348b into pressure contact with the peripheral portion of the substrate W supported on the support frame 336 and with the upper surface of the protruding portion 340 of the support frame 336, respectively, to thereby seal the peripheral portion and the back surface of the substrate W and hold the substrate W.

With the substrate W thus held, the substrate holder 316 is lowered. As the substrate W descends, the lower surface of the substrate stage 330 first comes into contact with the plating solution 312 in the plating bath 314, and the substrate W and the support frame 336 come to be heated (pre-heated) by the heat of the plating solution 312 itself. Before reaching the plating position, as necessary, the substrate holder 316 is stopped at the pre-heating position shown in FIG. 14 so as to heat the substrate W and the support frame 336 to a stable temperature by the heat of the plating solution 312 itself. Thereafter, the substrate holder 316 is lowered to the plating position shown in FIG. 15.

Since the substrate W and the support frame 336 of the substrate holding portion 332 are thus previously heated to the plating temperature before they are immersed in the plating solution 312, the substrate W can be kept at a uniform plating temperature over the entire surface from the initial stage of plating, whereby a plated film having a uniform film thickness can be formed. During the plating, it is possible to rotate the substrate W so as to make the density of hydrogen gas and the concentration of dissolved oxygen uniform over the surface to be plated.

After completion of the plating treatment, the substrate holder 316 is raised, and the plating solution remaining on the upper surface of the substrate W is removed e.g. by suction. Thereafter, the substrate holder 316 is transferred to a cleaning position, etc. While rotating the substrate W, a cleaning liquid is jetted from a cleaning liquid nozzle (not shown) onto the plated surface of the substrate W to cool the plated surface and, at the same time, dilute and clean the plated surface, thereby terminating the electroless plating reaction.

Thereafter, the substrate holding portion 332 is raised relative to the substrate stage 330, thereby releasing the holding of the substrate W. The plated substrate is then transferred e.g. by a hand of a robot to the next step.

FIG. 16 shows an electroless plating device according to still another embodiment of the present invention. This electroless plating device 10f adds the following construction to the electroless plating device 10e shown in FIGS. 14 and 15.

Specifically, the electroless plating device 10f includes a chamber 360 for hermetically closing in a space above the plating bath 314. The chamber 360 has an inert gas introduction inlet 360a for introducing an inert gas, such as N₂ gas, into the chamber 360.

Further, the electroless plating device 10f is also provided with an initial plating solution make-up tank 361. The plating solution supply pipe 320, extending from the initial plating solution make-up tank 361 to the plating bath 314, has on its way a pump 362 and a filter 363. The initial plating solution make-up tank 361 also communicates with the plating solution discharge hole 328 via a plating solution return pipe 364. The initial plating solution make-up tank 361 is equipped with a plating solution temperature regulator 365 for regulating the temperature of the plating solution 312 in the initial plating solution make-up tank 361. Further, a plurality of plating solution concentration adjustment tanks 366 for adjusting the concentration of the plating solution 312 are connected to the initial plating solution make-up tank 361.

By the operation of the pump 362, the plating solution 312 is allowed to circulate between the plating bath 314 and the initial plating solution make-up tank 361. Thus, the concentrations of various components of the plating solution 312 and the temperature of the solution can be controlled by the provision of the initial plating solution make-up tank 361.

According to this embodiment, by introducing an inert gas, such as N₂ gas, into the chamber 360, the adverse effect of dissolved oxygen in the plating solution 312 on the plated film can be eliminated. Further, the plating solution 312 with a controlled component concentration at a controlled temperature can be introduced sequentially into the plating bath 314.

In the above embodiments, the plating device utilizes a face-up system in which the substrate is plated in such a state that the surface to be plated faces upwardly. However, the present invention is also applicable to other plating devices in which the temperature of a substrate can be controlled so as to be constant by a fluid supplied to the back surface of the substrate. Therefore, the present invention is applicable to a plating device in which a substrate is plated in such a state that the surface to be plated faces downwardly (face down) or laterally. Thus, the present invention is not limited to a plating device utilizing a face-up system.

FIGS. 17 and 18 show an electroless plating apparatus utilizing a face-down system. This electroless plating device 10h has a substrate holder 410 for holding a substrate W, such as a semiconductor wafer, in such a manner that the surface S, to be plated, faces downward (facedown). A seal ring 414 for sealing an outer peripheral portion of the substrate W is mounted on the lower portion of the substrate holder 410. The substrate holder 410 is housed in a housing 412 so as to be movable vertically, and rotatable in unison with the housing 412 which is open downwardly. The housing 412 is connected to a lower end of a main shaft 416 which is vertically movable and rotatable, and has a lower end which projects inwardly and forms a holding claw 418 for holding an outer peripheral portion of the substrate W, and a circumferential wall having openings 420 for allowing the substrate W to be carried in or out. The electroless plating device 10h has a pipe (not shown) provided within the main shaft 416 for supplying a fluid to the back surface of the substrate, and a pipe 440 provided within the main shaft 416 and the substrate holder 410 for discharging the fluid from the back surface of the substrate. These pipes may separately be provided or may be integrally provided as a double tube.

A plating bath 424 for holding an electroless plating solution is disposed below the housing 412. The plating bath 424 has a plating chamber 428 therein which holds the plating solution. The periphery of the plating chamber 428 is surrounded by an overflow dam 430, and a plating solution discharge passage 432 is formed outwardly of the overflow dam 430. Thus, the plating solution flows upwardly and is introduced into the plating chamber 428, overflows the overflow dam 430, and is then discharged through the plating solution discharge passage 432 to the outside.

In the electroless plating apparatus 10h according to this embodiment, the substrate W is first introduced through the opening 420 into the housing 412, the substrate holder 410 is lowered so as to hold the substrate W placed on the holding claw 418. On the other hand, the plating solution heated to a fixed temperature is introduced into the plating chamber 428, and is caused to overflow the overflow dam 430. In such a state, the substrate W is lowered while it is rotated, whereby the substrate W is dipped in the plating solution in the plating chamber 428 to apply copper plating to a surface of the substrate W.

Though the above-described embodiments relate to application of the present invention to electroless plating devices, the present invention is of course applicable to electroplating devices in which a plating current is allowed to pass between a cathode and an anode.

As described hereinabove, according to the plating device of the present invention, a so-called face-up system or face-down system are employed. When plating is carried out by immersing a substrate, to be processed, in a plating solution while the back surface and the peripheral portion of the substrate are kept sealed, hydrogen gas generated during plating can be easily released from the surface, to be plated, of the substrate and plating can be carried out stably.

Further, by heating a substrate, to be processed, by the heat of a plating solution upon immersing the substrate in the plating solution, the substrate, to be processed, can be kept at a uniform plating temperature over the entire surface, whereby a plated film having a uniform film thickness can be formed.

Moreover, by putting a plating bath under an inert gas atmosphere, the adverse effect of dissolved oxygen in a plating solution on a plated film can be eliminated.

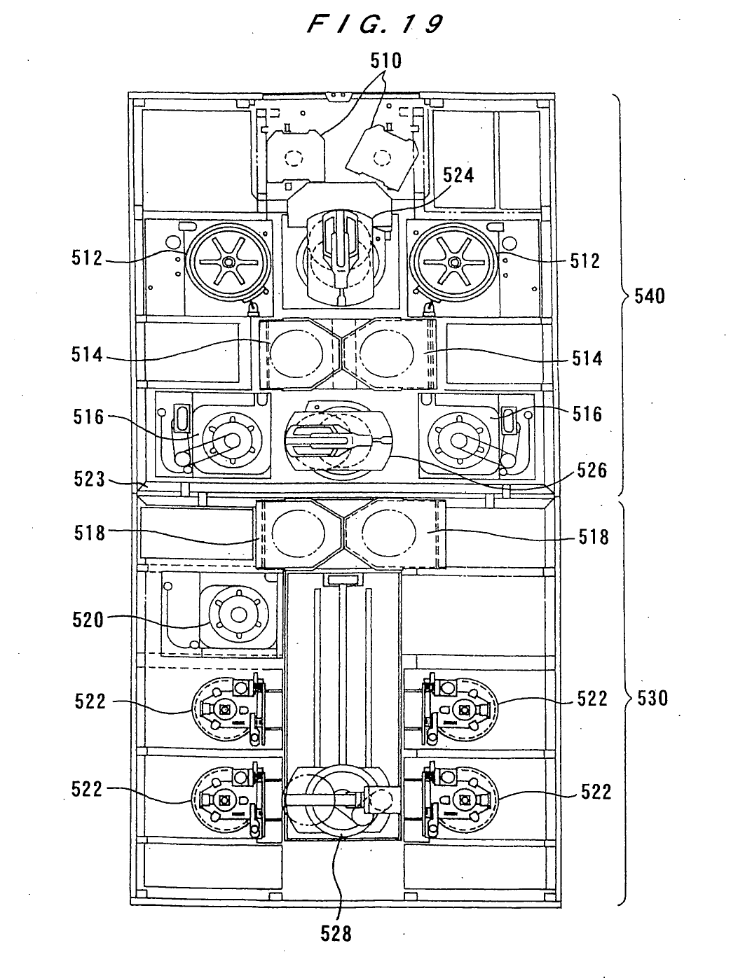

FIG. 19 is a plan view of an example of a substrate plating apparatus. The substrate plating apparatus comprises loading/unloading sections 510, each pair of cleaning/drying sections 512, first substrate stages 514, bevel-etching/chemical cleaning sections 516 and second substrate stages 518, a washing section 520 provided with a mechanism for reversing the substrate through 180°, and four plating apparatuses 522. The plating substrate apparatus is also provided with a first transferring device 524 for transferring a substrate between the loading/unloading sections 510, the cleaning/drying sections 512 and the first substrate stages 514, a second transferring device 526 for transferring a substrate between the first substrate stages 514, the bevel-etching/chemical cleaning sections 516 and the second substrate stages 518, and a third transferring device 528 for transferring the substrate between the second substrate stages 518, the washing section 520 and the plating apparatuses 522.

The substrate plating-apparatus has a partition wall 523 for dividing the plating apparatus into a plating space 530 and a clean space 540. Air can individually be supplied into and exhausted from each of the plating space 530 and the clean space 540. The partition wall 523 has a shutter (not shown) capable of opening and closing. The pressure of the clean space 540 is lower than the atmospheric pressure and higher than the pressure of the plating space 530. This can prevent the air in the clean space 540 from flowing out of the plating apparatus and can prevent the air in the plating space 530 from flowing into the clean space 540.

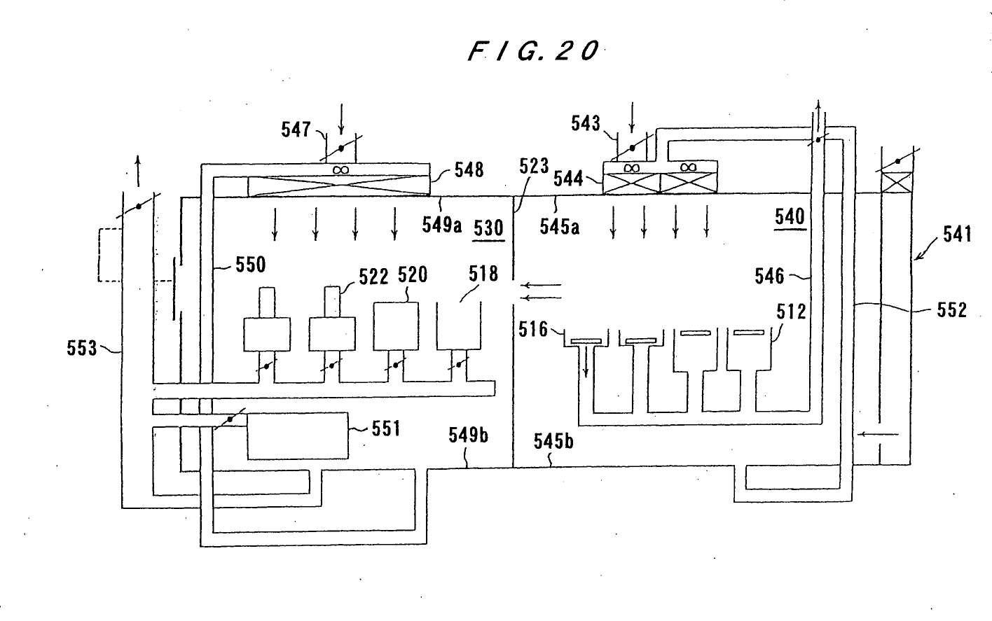

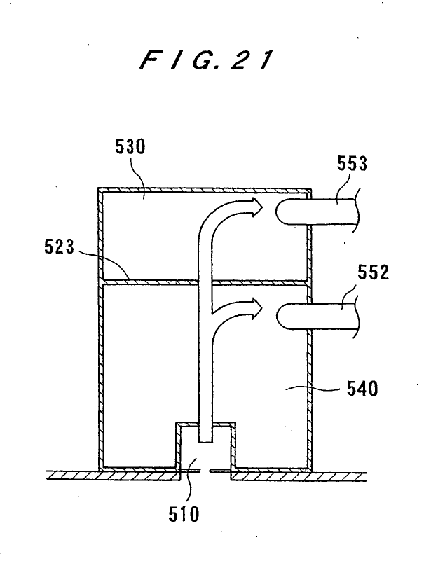

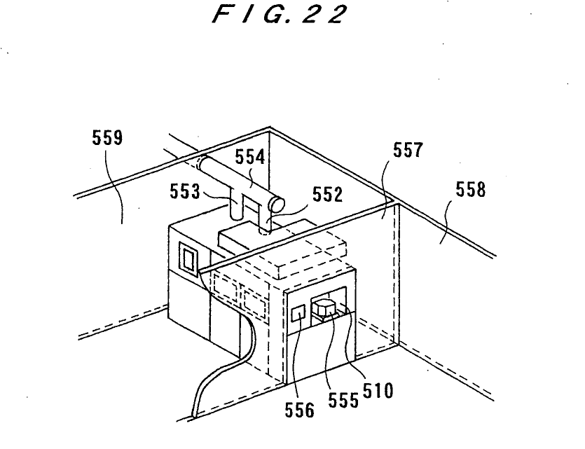

FIG. 20 is a schematic view showing an air current in the plating substrate apparatus. In the clean space 540, a fresh external air is introduced through a pipe 543 and pushed into the clean space 540 through a high-performance filter 544 by a fan. Hence, a down-flow clean air is supplied from a ceiling 545a to positions around the cleaning/drying sections 512 and the bevel-etching/chemical cleaning sections 516. A large part of the supplied clean air is returned from a floor 545b through a circulation pipe 552 to the ceiling 545a, and pushed-again into the clean space 540 through the high-performance filter 544 by the fan, to thus circulate in the clean space 540. A part of the air is discharged from the cleaning/drying sections 512 and the bevel-etching/chemical cleaning sections 516 through a pipe 546 to the exterior, so that the pressure of the clean space 540 is set to be lower than the atmospheric pressure.

The plating space 530 having the washing sections 520 and the plating apparatuses 522 therein is not a clean space (but a contamination zone). However, it is not acceptable to attach particles to the surface of the substrate. Therefore, in the plating space 530, a fresh external air is introduced through a pipe 547, and a down-flow clean air is pushed into the plating space 530 through a high-performance filter 548 by a fan, for thereby preventing particles from being attached to the surface of the substrate. However, if the whole flow rate of the down-flow clean air is supplied by only an external air supply and exhaust, then enormous air supply and exhaust are required. Therefore, the air is discharged through a pipe 553 to the exterior, and a large part of the down-flow is supplied by a circulating air through a circulation pipe 550 extended from a floor 549b, in such a state that the pressure of the plating space 530 is maintained to be lower than the pressure of the clean space 540.

Thus, the air returned to a ceiling 549a through the circulation pipe 550 is pushed again into the plating space 530 through the high-performance filter 548 by the fan. Hence, a clean air is supplied into the plating space 530 to thus circulate in the plating space 530. In this case, air containing chemical mist or gas emitted from the washing sections 520, the plating sections 522, the third transferring device 528, and a plating solution regulating bath 551 is discharged through the pipe 553 to the exterior. Thus, the pressure of the plating space 530 is controlled so as to be lower than the pressure of the clean space 540.

The pressure in the loading/unloading sections 510 is higher than the pressure in the clean space 540 which is higher than the pressure in the plating space 530. When the shutters (not shown) are opened, therefore, air flows successively through the loading/unloading sections 510, the clean space 540, and the plating space 530, as shown in FIG. 21. Air discharged from the clean space 540 and the plating space 530 flows through the ducts 552, 553 into a common duct 554 (see FIG. 22) which extends out of the clean room.

FIG. 22 shows in perspective the substrate plating apparatus shown in FIG. 19, which is placed in the clean room. The loading/unloading sections 510 includes a side wall which has a cassette transfer port 555 defined therein and a control panel 556, and which is exposed to a working zone 558 that is compartmented in the clean room by a partition wall 557. The partition wall 557 also compartments a utility zone 559 in the clean room in which the substrate plating apparatus is installed. Other sidewalls of the substrate plating apparatus are exposed to the utility zone 559 whose air cleanness is lower than the air cleanness in the working zone 558.

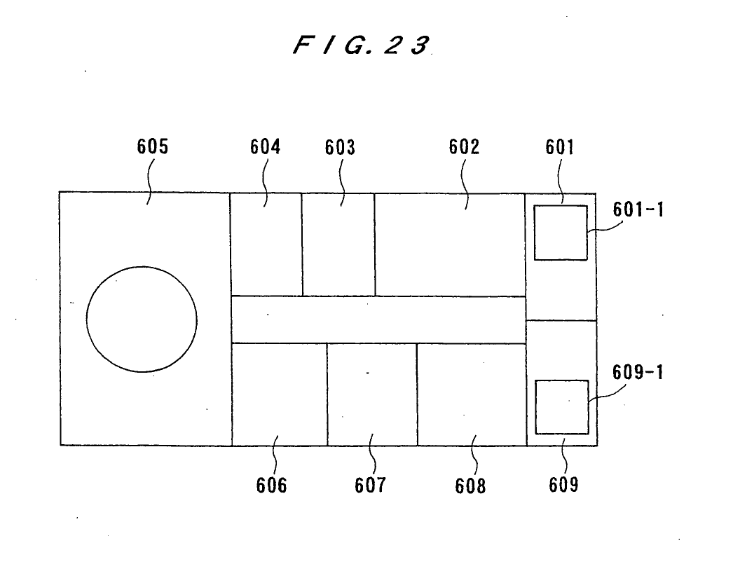

FIG. 23 is a plan view of another example of a substrate plating apparatus. The substrate plating apparatus shown in FIG. 23 comprises a loading unit 601 for loading a semiconductor substrate, a copper plating chamber 602 for plating a semiconductor substrate with copper, a pair of water cleaning chambers 603, 604 for cleaning a semiconductor substrate with water, a chemical mechanical polishing unit 605 for chemically and mechanically polishing a semiconductor substrate, a pair of water cleaning chambers 606, 607 for cleaning a semiconductor substrate with water, a drying chamber 608 for drying a semiconductor substrate, and an unloading unit 609 for unloading a semiconductor substrate with an interconnection film thereon. The substrate plating apparatus also has a substrate transfer mechanism (not shown) for transferring semiconductor substrates to the chambers 602, 603, 604, the chemical mechanical polishing unit 605, the chambers 606, 607, 608, and the unloading unit 609. The loading unit 601, the chambers 602, 603, 604, the chemical mechanical polishing unit 605, the chambers 606, 607, 608, and the unloading unit 609 are combined into a single unitary arrangement as an apparatus.

The substrate plating apparatus operates as follows: The substrate transfer mechanism transfers a semiconductor substrate W on which an interconnection film has not yet been formed from a substrate cassette 601-1 placed in the loading unit 601 to the copper plating chamber 602. In the copper plating chamber 602, a plated copper film is formed on a surface of the semiconductor substrate W having an interconnection region composed of an interconnection trench and an interconnection hole (contact hole).

After the plated copper film is formed on the semiconductor substrate W in the copper plating chamber 602, the semiconductor substrate W is transferred to one of the water cleaning chambers 603, 604 by the substrate transfer mechanism and cleaned by water in one of the water cleaning chambers 603, 604. The cleaned semiconductor substrate W is, transferred to the chemical mechanical polishing unit 605 by the substrate transfer mechanism. The chemical mechanical polishing unit 605 removes the unwanted plated copper film from the surface of the semiconductor substrate W, leaving a portion of the plated copper film in the interconnection trench and the interconnection hole. A barrier layer made of TiN or the like is formed on the surface of the semiconductor substrate W, including the inner surfaces of the interconnection trench and the interconnection hole, before the plated copper film is deposited.

Then, the semiconductor substrate W with the remaining plated copper film is transferred to one of the water cleaning chambers 606, 607 by the substrate transfer mechanism and cleaned by water in one of the water cleaning chambers 606, 607. The cleaned semiconductor substrate W is then dried in the drying chamber 608, after which the dried semiconductor substrate W with the remaining plated copper film serving as an interconnection film is placed into a substrate cassette 609-1 in the unloading unit 609.

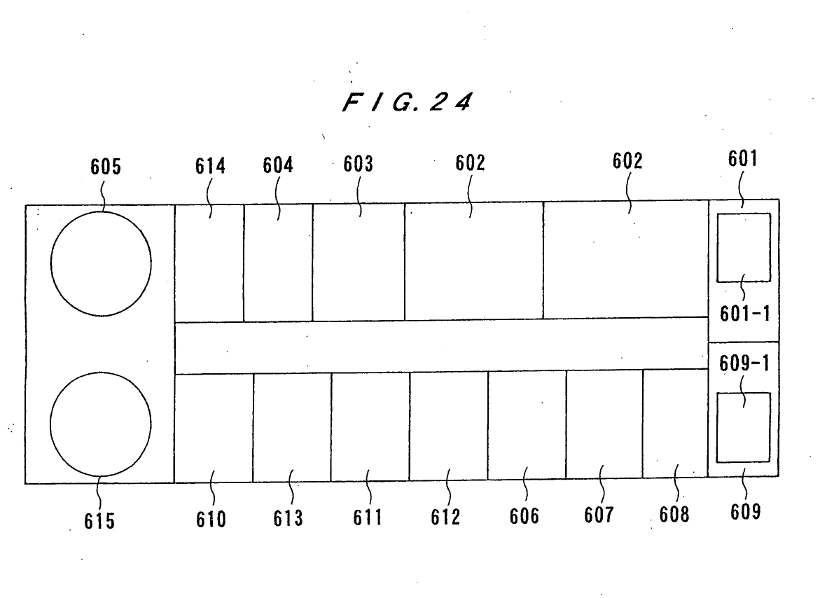

FIG. 24 shows a plan view of still another example of a substrate plating apparatus. The substrate plating apparatus shown in FIG. 24 differs from the substrate plating apparatus shown in FIG. 23 in that it additionally includes a copper plating chamber 602, a water cleaning chamber 610, a pretreatment chamber 611, a protective layer plating chamber 612 for forming a protective plated layer on a plated copper film on a semiconductor substrate, water cleaning chamber 613, 614, and a chemical mechanical polishing unit 615. The loading unit 601, the chambers 602, 602, 603, 604, 614, the chemical mechanical polishing unit 605, 615, the chambers 606, 607, 608, 610, 611, 612, 613, and the unloading unit 609 are combined into a single unitary arrangement as an apparatus.

The substrate plating apparatus shown in FIG. 24 operates as follows: A semiconductor substrate W is supplied from the substrate cassette 601-1 placed in the loading unit 601 successively to one of the copper plating chambers 602, 602. In one of the copper plating chamber 602, 602, a plated copper film is formed on a surface of a semiconductor substrate W having an interconnection region composed of an interconnection trench and an interconnection hole (contact hole). The two copper plating chambers 602, 602 are employed to allow the semiconductor substrate W to be plated with a copper film for a long period of time. Specifically, the semiconductor substrate W may be plated with a primary copper film according to electroless plating in one of the copper plating chamber 602, and then plated with a secondary copper film according to electroplating in the other copper plating chamber 602. The substrate plating apparatus may have more than two copper plating chambers.

The semiconductor substrate W with the plated copper film formed thereon is cleaned by water in one of the water cleaning chambers 603, 604. Then, the chemical mechanical polishing unit 605 removes the unwanted portion of the plated copper film from the surface of the semiconductor substrate W, leaving a portion of the plated copper film in the interconnection trench and the interconnection hole.

Thereafter, the semiconductor substrate W with the remaining plated copper film is transferred to the water cleaning chamber 610, in which the semiconductor substrate W is cleaned with water. Then, the semiconductor substrate W is transferred to the pretreatment chamber 611, and pretreated therein for the deposition of a protective plated layer. The pretreated semiconductor substrate W is transferred to the protective layer-plating chamber 612. In the protective layer plating chamber 612, a protective plated layer is formed on the plated copper film in the interconnection region on the semiconductor substrate W. For example, the protective plated layer is formed with an alloy of nickel (Ni) and boron (B) by electroless plating.

After semiconductor substrate is cleaned in one of the water cleaning chamber 613, 614, an upper portion of the protective plated layer deposited on the plated copper film is polished off to planarize the protective plated layer, in the chemical mechanical polishing unit 615.

After the protective plated layer is polished, the semiconductor substrate W is cleaned by water in one of the water cleaning chambers 606, 607, dried in the drying chamber 608, and then transferred to the substrate cassette 609-1 in the unloading unit 609.

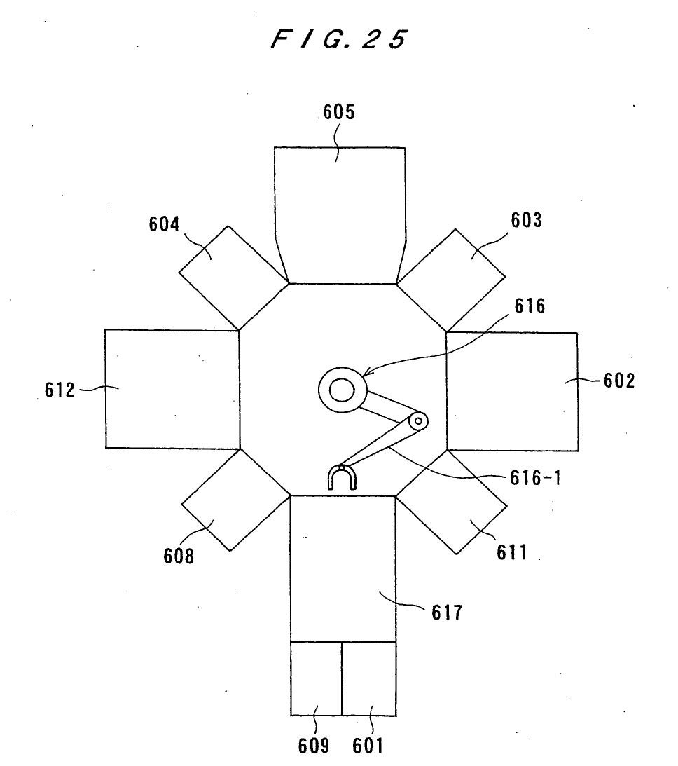

FIG. 25 is a plan view of still another example of a substrate plating apparatus. As shown in FIG. 25, the substrate plating apparatus includes a robot 616 at its center which has a robot arm 616-1, and also has a copper plating chamber 602, a pair of water cleaning chambers 603, 604, a chemical mechanical polishing unit 605, a pretreatment chamber 611, a protective layer plating chamber 612, a drying chamber 608, and a loading/unloading station 617 which are disposed around the robot 616 and positioned within the reach of the robot arm 616-1. A loading unit 601 for loading semiconductor substrates and an unloading unit 609 for unloading semiconductor substrates is disposed adjacent to the loading/unloading station 617. The robot 616, the chambers 602, 603, 604, the chemical mechanical polishing unit 605, the chambers 608, 611, 612, the loading/unloading station 617, the loading unit 601, and the unloading unit 609 are combined into a single unitary arrangement as an apparatus.

The substrate plating apparatus shown in FIG. 25 operates as follows:

A semiconductor substrate to be plated is transferred from the loading unit 601 to the loading/unloading station 617, from which the semiconductor substrate is received by the robot arm 616-1 and transferred thereby to the copper plating chamber 602. In the copper plating chamber 602, a plated copper film is formed on a surface of the semiconductor substrate which has an interconnection region composed of an interconnection trench and an interconnection hole. The semiconductor substrate with the plated copper film formed thereon is transferred by the robot arm 616-1 to the chemical mechanical polishing unit 605. In the chemical mechanical polishing unit 605, the plated copper film is removed from the surface of the semiconductor substrate W, leaving a portion of the plated copper film in the interconnection trench and the interconnection hole.

The semiconductor substrate is then transferred by the robot arm 616-1 to the water-cleaning chamber 604, in which the semiconductor substrate is cleaned by water. Thereafter, the semiconductor substrate is transferred by the robot arm 616-1 to the pretreatment chamber 611, in which the semiconductor substrate is pretreated therein for the deposition of a protective plated layer. The pretreated semiconductor substrate is transferred by the robot arm 616-1 to the protective layer plating chamber 612. In the protective layer plating chamber 612, a protective plated layer is formed on the plated copper film in the interconnection region on the semiconductor substrate W. The semiconductor substrate with the protective plated layer formed thereon is transferred by the robot arm 616-1 to the water cleaning chamber 604, in which the semiconductor substrate is cleaned by water. The cleaned semiconductor substrate is transferred by the robot arm 616-1 to the drying chamber 608, in which the semiconductor substrate is dried. The dried semiconductor substrate is transferred by the robot arm 616-1 to the loading/unloading station 617, from which the plated semiconductor substrate is transferred to the unloading unit 609.

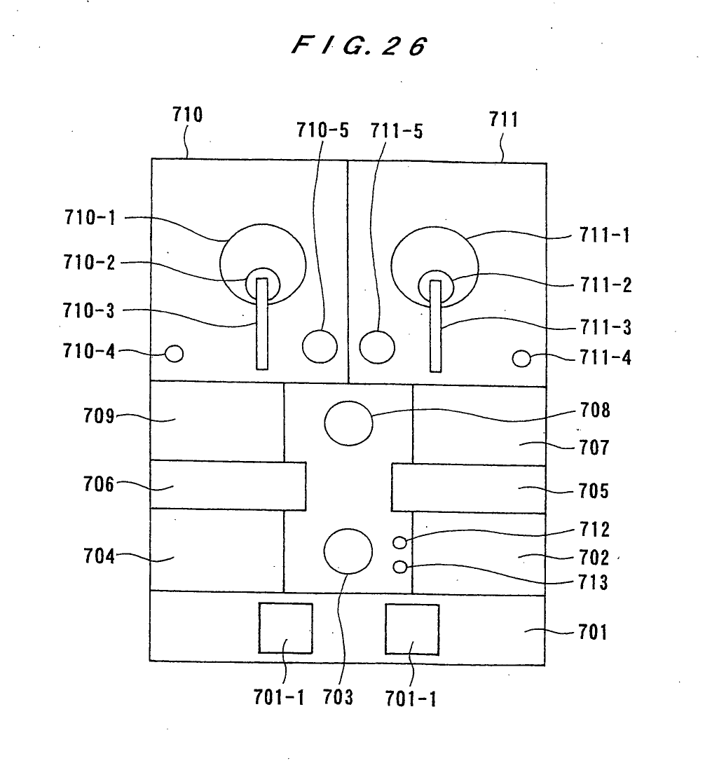

FIG. 26 is a view showing the plan constitution of another example of a semiconductor substrate processing apparatus. The semiconductor substrate processing apparatus is of a constitution in which there are provided a loading/unloading section 701, a plated Cu film forming unit 702, a first robot 703, a third cleaning machine 704, a reversing machine 705, a reversing machine 706, a second cleaning machine 707, a second robot 708, a first cleaning machine 709, a first polishing apparatus 710, and a second polishing apparatus 711. A before-plating and after-plating film thickness measuring instrument 712 for measuring the film thicknesses before and after plating, and a dry state film thickness measuring instrument 713 for measuring the film thickness of a semiconductor substrate W in a dry state after polishing are placed near the first robot 703.

The first polishing apparatus (polishing unit) 710 has a polishing table 710-1, a top ring 710-2, a top ring head 710-3, a film thickness measuring instrument 710-4, and a pusher 710-5. The second polishing apparatus. (polishing unit) 711 has a polishing table 711-1, a top ring 711-2, a top ring head 711-3, a film thickness measuring instrument 711-4, and a pusher 711-5.

A cassette 701-1 accommodating the semiconductor substrates W, in which a via hole and a trench for interconnect are formed, and a seed layer is formed thereon is placed on a loading port of the loading/unloading section 701. The first robot 703 takes out the semiconductor substrate W from the cassette 701-1, and carries the semiconductor substrate W into the plated Cu film forming unit 702 where a plated Cu film is formed. At this time, the film thickness of the seed layer is measured with the before-plating and after-plating film thickness measuring instrument 712. The plated Cu film is formed by carrying out hydrophilic treatment of the face of the semiconductor substrate W, and then Cu plating. After formation of the plated Cu film, rinsing or cleaning of the semiconductor substrate W is carried out in the plated Cu film forming unit 702.

When the semiconductor substrate W is taken out from the plated Cu film forming unit 702 by the first robot 703, the film thickness of the plated Cu film is measured with the before-plating and after-plating film thickness measuring instrument 712. The results of its measurement are recorded into a recording device (not shown) as record data on the semiconductor substrate, and are used for judgment of an abnormality of the plated Cu film forming unit 702. After measurement of the film thickness, the first robot 703 transfers the semiconductor substrate W to the reversing machine 705, and the reversing machine 705 reverses the semiconductor substrate W (the surface on which the plated Cu film has been formed faces downward). The first polishing apparatus 710 and the second polishing apparatus 711 perform polishing in a serial mode and a parallel mode. Next, polishing in the serial mode will be described.

In the serial mode polishing, a primary polishing is performed by the polishing apparatus 710, and a secondary polishing is performed by the polishing apparatus 711. The second robot 708 picks up the semiconductor substrate W on the reversing machine 705, and places the semiconductor substrate W on the pusher 710-5 of the polishing apparatus 710. The top ring 710-2 attracts the semiconductor substrate W on the pusher 710-5 by suction, and brings the surface of the plated Cu film of the semiconductor substrate W into contact with a polishing surface of the polishing table 710-1 under pressure to perform a primary polishing. With the primary polishing, the plated Cu film is basically polished. The polishing surface of the polishing table 710-1 is composed of foamed polyurethane such as IC1000, or a material having abrasive grains fixed thereto or impregnated therein. Upon relative movements of the polishing surface and the semiconductor substrate W, the plated Cu film is polished.

After completion of polishing of the plated Cu film, the semiconductor substrate W is returned onto the pusher 710-5 by the top ring 710-2. The second robot 708 picks up the semiconductor substrate W and introduces it into the first cleaning machine 709. At this time, a chemical liquid may be ejected toward the face and backside of the semiconductor substrate W on the pusher 710-5 to remove particles therefrom or cause particles to be difficult to adhere thereto.

After completion of cleaning in the first cleaning machine 709, the second robot 708 picks up the semiconductor substrate W, and places the semiconductor substrate W on the pusher 711-5 of the second polishing apparatus 711. The top ring 711-2 attracts the semiconductor substrate W on the pusher 711-5 by suction, and brings the surface of the semiconductor substrate W, which has the barrier layer formed thereon, into contact with a polishing surface of the polishing table 711-1 under pressure to perform the secondary polishing. The constitution of the polishing table is the same as the top ring 711-2. With this secondary polishing, the barrier layer is polished. However, there may be a case in which a Cu film and an oxide film left after the primary polishing are also polished.

A polishing surface of the polishing table 711-1 is composed of foamed polyurethane such as IC1000, or a material having abrasive grains fixed thereto or impregnated therein. Upon relative movements of the polishing surface and the semiconductor substrate W, polishing is carried out. At this time, silica, alumina, ceria, or the like is used as abrasive grains or slurry. A chemical liquid is adjusted depending on the type of the film to be polished.

Detection of an end point of the secondary polishing is performed by measuring the film thickness of the barrier layer mainly with the use of the optical film thickness measuring instrument, and detecting the film thickness which has become zero, or the surface of an insulating film comprising SiO₂ shows up. Furthermore, a film thickness measuring instrument with an image processing function is used as the film thickness measuring instrument 711-4 provided near the polishing table 711-1. By use of this measuring instrument, measurement of the oxide film is made, the results are stored as processing records of the semiconductor substrate W, and used for judging whether the semiconductor substrate W in which secondary polishing has been finished can be transferred to a subsequent step or not. If the endpoint of the secondary polishing is not reached, re-polishing is performed. If over-polishing has been performed beyond a prescribed value due to any abnormality, then the semiconductor substrate processing apparatus is stopped to avoid next polishing so that defective products will not increase.

After completion of the secondary polishing, the semiconductor substrate W is moved to the pusher 711-5 by the top ring 711-2. The second robot 708 picks up the semiconductor substrate W on the pusher 711-5. At this time, a chemical liquid may be ejected toward the face and backside of the semiconductor substrate W on the pusher 711-5 to remove particles therefrom or cause particles to be difficult to adhere thereto.

The second robot 708 carries the semiconductor substrate W into the second cleaning machine 707 where cleaning of the semiconductor substrate W is performed. The constitution of the second cleaning machine 707 is also the same as the constitution of the first cleaning machine 709. The face of the semiconductor substrate W is scrubbed with the PVA sponge rolls using a cleaning liquid comprising pure water to which a surface active agent, a chelating agent, or a pH regulating agent is added. A strong chemical liquid such as DHF is ejected from a nozzle toward the backside of the semiconductor substrate W to perform etching of the diffused Cu thereon. If there is no problem of diffusion, scrubbing cleaning is performed with the PVA sponge rolls using the same chemical liquid as that used for the face.

After completion of the above cleaning, the second robot 708 picks up the semiconductor substrate W and transfers it to the reversing machine 706, and the reversing machine 706 reverses the semiconductor substrate W. The semiconductor substrate W which has been reversed is picked up by the first robot 703, and transferred to the third cleaning machine 704. In the third cleaning machine 704, megasonic water excited by ultrasonic vibrations is ejected toward the face of the semiconductor substrate W to clean the semiconductor substrate W. At this time, the face of the semiconductor substrate W may be cleaned with a known pencil type sponge using a cleaning liquid comprising pure water to which a surface active agent, a chelating agent, or a pH regulating agent is added. Thereafter, the semiconductor substrate W is dried by spin-drying.

As described above, if the film thickness has been measured with the film thickness measuring instrument 711-4 provided near the polishing table 711-1, then the semiconductor substrate W is not subjected to further process and is accommodated into the cassette placed on the unloading port of the loading/unloading section 701.

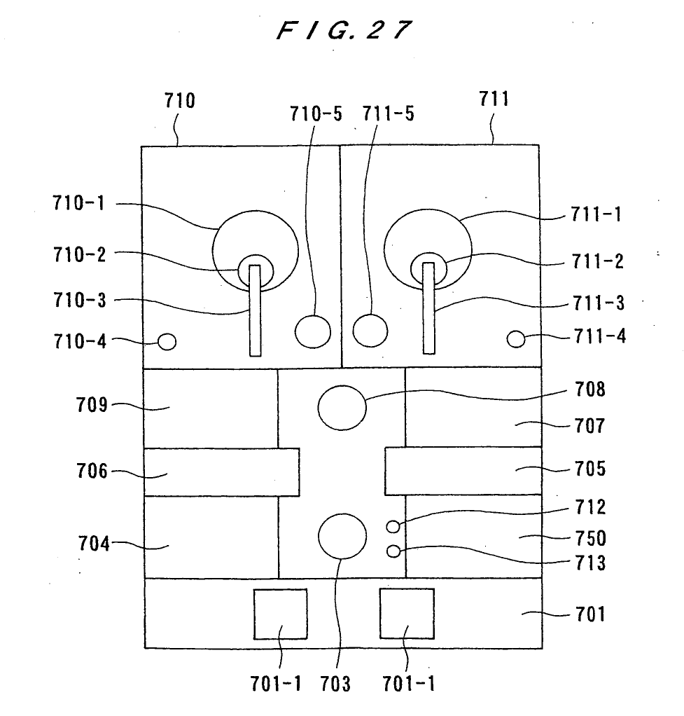

FIG. 27 is a view showing the plan constitution of another example of a semiconductor substrate processing apparatus. The substrate processing apparatus differs from the substrate processing apparatus shown in FIG. 26 in that a cap plating unit 750 is provided instead of the plated Cu film forming unit 702 in FIG. 26.

A cassette 701-1 accommodating the semiconductor substrates W formed plated Cu film is placed on a load port of a loading/unloading section 701. The semiconductor substrate W taken out from the cassette 701-1 is transferred to the first polishing apparatus 710 or second polishing apparatus 711 in which the surface of the plated Cu film is polished. After completion of polishing of the plated Cu film, the semiconductor substrate W is cleaned in the first cleaning machine 709.

After completion of cleaning in the first cleaning machine 709, the semiconductor substrate W is transferred to the cap plating unit 750 where cap plating is applied onto the surface of the plated Cu film with the aim of preventing oxidation of plated Cu film due to the atmosphere. The semiconductor substrate to which cap plating has been applied is carried by the second robot 708 from the cap plating unit 750 to the second cleaning machine 707 where it is cleaned with pure water or deionized water. The semiconductor substrate after completion of cleaning is returned into the cassette 701-1 placed on the loading/unloading section 701.

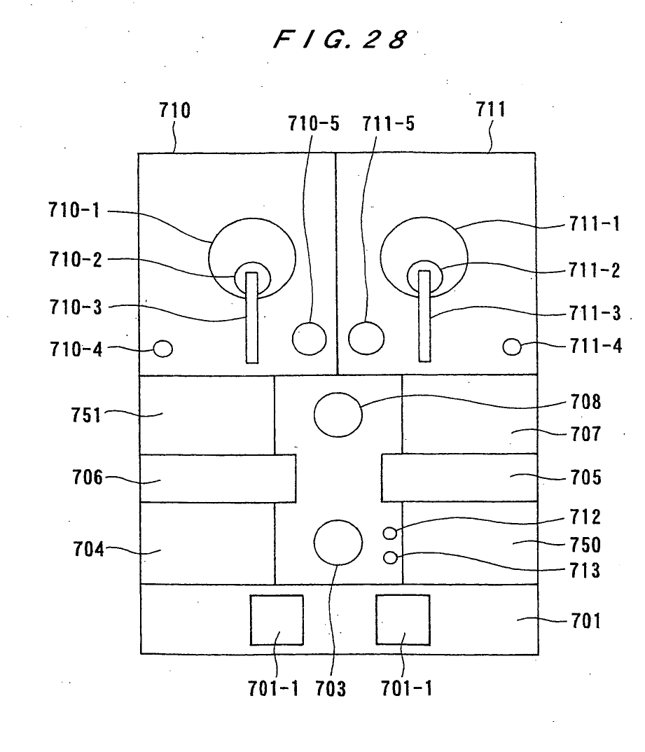

FIG. 28 is a view showing the plan constitution of still another example of a semiconductor substrate processing apparatus. The substrate processing apparatus differs from the substrate processing apparatus shown in FIG. 27 in that an annealing unit 751 is provided instead of the first cleaning machine 709 in FIG. 27.

The semiconductor substrate W, which is polished in the polishing unit 710 or 711, and cleaned in the second cleaning machine 707 described above, is transferred to the cap plating unit 750 where cap plating is applied onto the surface of the plated Cu film. The semiconductor substrate to which cap plating has been applied is carried by the second robot 708 from the cap plating unit 750 to the second cleaning machine 707 where it is cleaned.

After completion of cleaning in the second cleaning machine 707, the semiconductor substrate W is transferred to the annealing unit 751 in which the substrate is annealed, whereby the plated Cu film is alloyed so as to increase the electromigration resistance of the plated Cu film. The semiconductor substrate W to which annealing treatment has been applied is carried from the annealing unit 751 to the second cleaning machine 707 where it is cleaned with pure water or deionized water. The semiconductor substrate W after completion of cleaning is returned into the cassette 701-1 placed on the loading/unloading section 701.

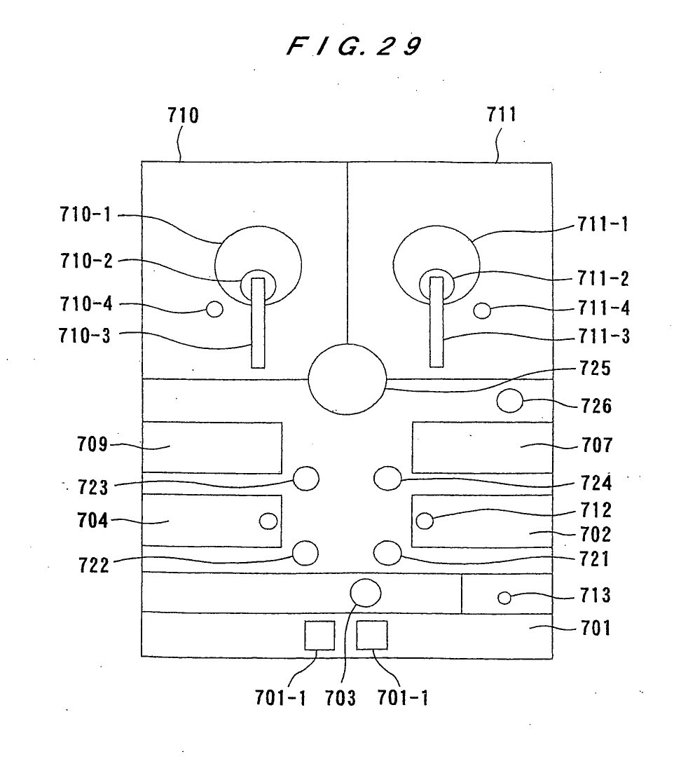

FIG. 29 is a view showing a plan layout constitution of another example of the substrate processing apparatus. In FIG. 29, portions denoted by the same reference numerals as those in FIG. 26 show the same or corresponding portions. In the substrate processing apparatus, a pusher indexer 725 is disposed close to a first polishing apparatus 710 and a second polishing apparatus 711. Substrate placing tables 721, 722 are disposed close to a third cleaning machine 704 and a plated Cu film forming unit 702, respectively. A robot 723 is disposed close to a first cleaning machine 709 and the third cleaning machine 704. Further, a robot 724 is disposed close to a second cleaning machine 707 and the plated Cu film forming unit 702, and a dry state film thickness measuring instrument 713 is disposed close to a loading/unloading section 701 and a first robot 703.

In the substrate processing apparatus of the above constitution, the first robot 703 takes out a semiconductor substrate W from a cassette 701-1 placed on the load port of the loading/unloading section 701. After the film thicknesses of a barrier layer and a seed layer are measured with the dry state film thickness measuring instrument 713, the first robot 703 places the semiconductor substrate Won the substrate placing table 721. In the case where the dry state film thickness measuring instrument 713 is provided on the hand of the first robot 703, the film thicknesses are measured thereon, and the substrate-is placed on the substrate placing table 721. The second robot 723 transfers the semiconductor substrate W on the substrate placing table 721 to the plated Cu film forming unit 702 in which a plated Cu film is formed. After formation of the plated Cu film, the film thickness of the plated Cu film is measured with a before-plating and after-plating film thickness measuring instrument 712. Then, the second robot 723 transfers the semiconductor substrate W to the pusher indexer 725 and loads it thereon.

[Serial Mode]

In the serial mode, a top ring 710-2 holds the semiconductor substrate W on the pusher indexer 725 by suction, transfers it to a polishing table 710-1, and presses the semiconductor substrate W against a polishing surface on the polishing table 710-1 to perform polishing. Detection of the end point of polishing is performed by the same method as described above. The semiconductor substrate W after completion of polishing is transferred to the pusher indexer 725 by the top ring 710-2, and loaded thereon. The second robot 723 takes out the semiconductor substrate W, and carries it into the first cleaning machine 709 for cleaning. Then, the semiconductor substrate W is transferred to the pusher indexer 725, and loaded thereon.

A top ring 711-2 holds the semiconductor substrate W on the pusher indexer 725 by suction, transfers it to a polishing table 711-1, and presses the semiconductor substrate W against a polishing surface on the polishing table 711-1 to perform polishing. Detection of the end point of polishing is performed by the same method as described above. The semiconductor substrate W after completion of polishing is transferred to the pusher indexer 725 by the top ring 711-2, and loaded thereon. The third robot 724 picks up the semiconductor substrate W, and its film thickness is measured with a film thickness measuring instrument 726. Then, the semiconductor substrate W is carried into the second cleaning machine 707 for cleaning. Thereafter, the semiconductor substrate W is carried into the third cleaning machine 704, where it is cleaned and then dried by spin-drying. Then, the semiconductor substrate W is picked up by the third robot 724, and placed on the substrate placing table 722.

[Parallel Mode]

In the parallel mode, the top ring 710-2 or 711-2 holds the semiconductor substrate W on the pusher indexer 725 by suction, transfers it to the polishing-table 710-1 or 711-1, and presses the semiconductor substrate W against the polishing surface on the polishing table 710-1 or 711-1 to perform polishing. After measurement of the film thickness, the third robot 724 picks up the semiconductor substrate W, and places it on the substrate placing table 722.

The first robot 703 transfers the semiconductor substrate W on the substrate placing table 722 to the dry state film thickness measuring instrument 713. After the film thickness is measured, the semiconductor substrate W is returned to the cassette 701-1 of the loading/unloading section 701.

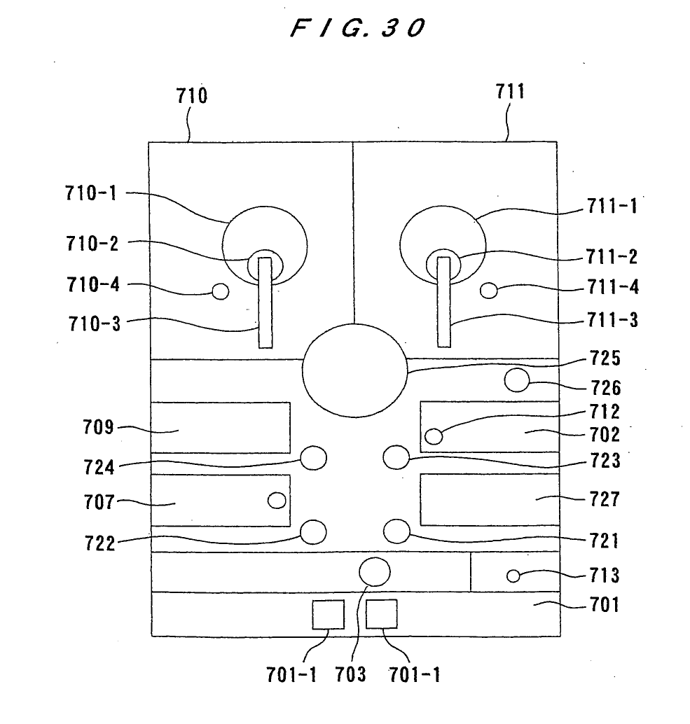

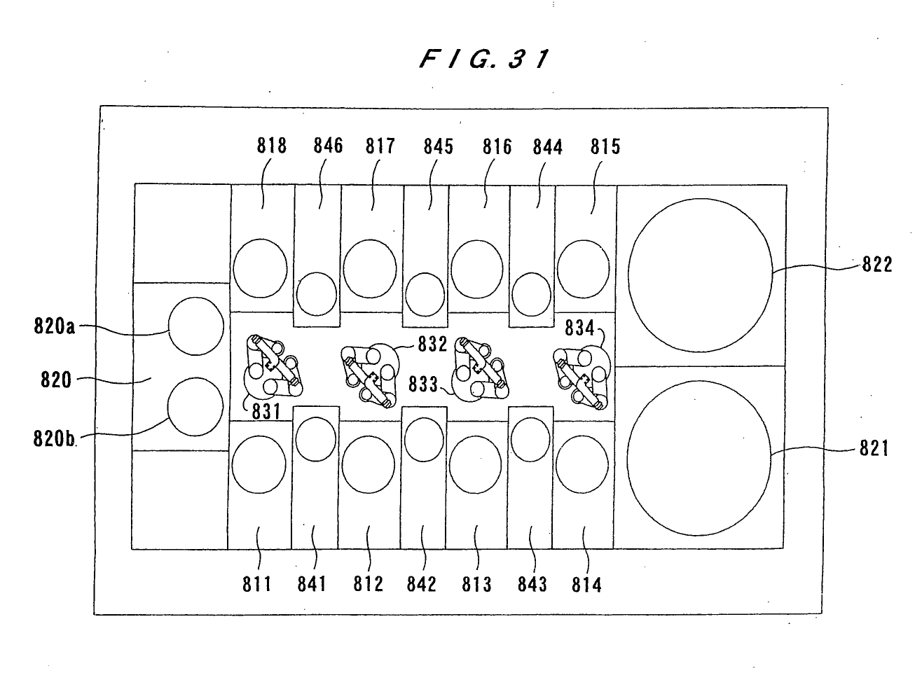

FIG. 30 is a view showing another plan layout constitution of the substrate processing apparatus. The substrate processing apparatus is such a substrate processing apparatus which forms a seed layer and a plated Cu film on a semiconductor substrate W having no seed layer formed thereon, and polishes these films to form interconnects.

In the substrate polishing apparatus, a pusher indexer 725 is disposed close to a first polishing apparatus 710 and a second polishing apparatus 711, substrate placing tables 721, 722 are disposed close to a second cleaning machine 707 and a seed layer forming unit 727, respectively, and a robot 723 is disposed close to the seed layer forming unit 727 and a plated Cu film forming unit 702. Further, a robot 724 is disposed close to a first cleaning machine 709 and the second cleaning machine 707, and a dry state film thickness measuring instrument 713 is disposed close to a loading/unloading section 701 and a first robot 703.

The first robot 703 takes out a semiconductor substrate W having a barrier layer thereon from a cassette 701-1 placed on the load port of the loading/unloading section 701, and places it on the substrate placing table 721. Then, the second robot 723 transfers the semiconductor substrate W to the seed layer forming unit 727 where a seed layer is formed. The seed layer is formed by electroless plating. The second robot 723 enables the semiconductor substrate having the seed layer formed thereon to be measured in thickness of the seed layer by the before-plating and after-plating film thickness measuring instrument 712. After measurement of the film thickness, the semiconductor substrate is carried into the plated Cu film forming unit 702 where a plated Cu film is formed.

After formation of the plated Cu film, its film thickness is measured, and the semiconductor substrate is transferred to a pusher indexer 725. A top ring 710-2 or 711-2 holds the semiconductor substrate W on the pusher indexer 725 by suction, and transfers it to a polishing table 710-1 or 711-1 to perform polishing. After polishing, the top ring 710-2 or 711-2 transfers the semiconductor substrate W to a film thickness measuring instrument 710-4 or 711-4 to measure the film thickness. Then, the top ring 710-2 or 711-2 transfers the semiconductor substrate W to the pusher indexer 725, and places it thereon.

Then, the third robot 724 picks up the semiconductor substrate W from the pusher indexer 725, and carries it into the first cleaning machine 709. The third robot 724 picks up the cleaned semiconductor substrate W from the first cleaning machine 709, carries it into the second cleaning machine 707, and places the cleaned and dried semiconductor substrate on the substrate placing table 722. Then, the first robot 703 picks up the semiconductor substrate W, and transfers it to the dry state film thickness measuring instrument 713 in which the film thickness is measured, and the first robot 703 carries it into the cassette 701-1 placed on the unload port of the loading/unloading section 701.

In the substrate processing apparatus shown in FIG. 30, interconnects are formed by forming a barrier layer, a seed layer and a plated Cu film on a semiconductor substrate W having a via hole or a trench of a circuit pattern formed therein, and polishing them.

The cassette 701-1 accommodating the semiconductor substrates W before formation of the barrier layer is placed on the load port of the loading/unloading section 701. The first robot 703 takes out the semiconductor substrate W from the cassette 701-1 placed on the load port of the loading/unloading section 701, and places it on the substrate placing table 721. Then, the second robot 723 transfers the semiconductor substrate W to the seed layer forming unit 727 where a barrier layer and a seed layer are formed. The barrier layer and the seed layer are formed by electroless plating. The second robot 723 brings the semiconductor substrate W having the barrier layer and the seed layer formed thereon to the before-plating and after-plating film thickness measuring instrument 712 which measures the film thicknesses of the barrier layer and the seed layer. After measurement of the film thicknesses, the semiconductor substrate W is carried into the plated Cu film forming unit 702 where a plated Cu film is formed.

FIG. 31 is a view showing plan layout constitution of another example of the substrate processing apparatus. In the substrate processing apparatus, there are provided a barrier layer forming unit 811, a seed layer forming unit 812, a plated film forming unit 813, an annealing unit 814, a first cleaning unit 815, a bevel and backside cleaning unit 816, a cap plating unit 817, a second cleaning unit 818, a first aligner and film thickness measuring instrument 841, a second aligner and film thickness measuring instrument 842, a first substrate reversing machine 843, a second substrate reversing machine 844, a substrate temporary placing table 845, a third film thickness measuring instrument 846, a loading/unloading section 820, a first polishing apparatus 821, a second polishing apparatus 822, a first robot 831, a second robot 832, a third robot 833, and a fourth robot 834. The film thickness measuring instruments 841, 842, and 846 are units, have the same size as the frontage dimension of other units (plating, cleaning, annealing units, and the like), and are thus interchangeable.

In this example, an electroless Ru plating apparatus can be used as the barrier layer forming unit 811, an electroless Cu plating apparatus as the seed layer forming unit 812, and an electroplating apparatus as the plated film forming unit 813.

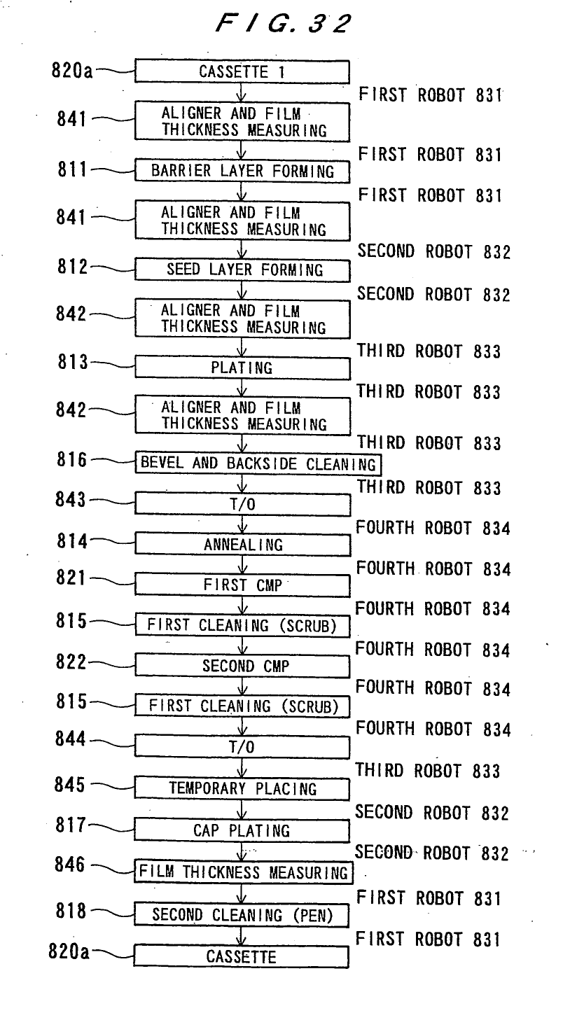

FIG. 32 is a flow chart showing the flow of the respective steps in the present substrate processing apparatus. The respective steps in the apparatus will be described according to this flow chart. First, a semiconductor substrate taken out by the first robot 831 from a cassette 820a placed on the load and unload section 820 is placed in the first aligner and film thickness measuring instrument 841, in such a state that its surface, to be plated, faces upward. In order to set a reference point for a position at which film thickness measurement is made, notch alignment for film thickness measurement is performed, and then film thickness data on the semiconductor substrate before formation of a Cu film are obtained.

Then, the semiconductor substrate is transferred to the barrier layer forming unit 811 by the first robot 831. The barrier layer forming unit 811 is such an apparatus for forming a barrier layer on the semiconductor substrate by electroless Ru plating, and the barrier layer forming unit 811 forms an Ru film as a film for preventing Cu from diffusing into an interlayer insulator film (e.g. SiO₂) of a semiconductor device. The semiconductor substrate discharged after cleaning and drying steps is transferred by the first robot 831 to the first aligner and film thickness measuring instrument 841, where the film thickness of the semiconductor substrate, i.e., the film thickness of the barrier layer is measured.

The semiconductor substrate after film thickness measurement is carried into the seed layer forming unit 812 by the second robot 832, and a seed layer is formed on the barrier layer by electroless Cu plating. The semiconductor substrate discharged after cleaning and drying steps is transferred by the second robot 832 to the second aligner and film thickness measuring instrument 842 for determination of a notch position, before the semiconductor substrate is transferred to the plated film forming unit 813, which is an impregnation plating unit, and then notch alignment for Cu plating is performed by the film thickness measuring instrument 842. If necessary, the film thickness of the semiconductor substrate before formation of a Cu film may be measured again in the film thickness measuring instrument 842.

The semiconductor substrate which has completed notch alignment is transferred by the third robot 833 to the plated film forming unit 813 where Cu plating is applied to the semiconductor substrate. The semiconductor substrate discharged after cleaning and drying steps is transferred by the third robot 833 to the bevel and backside cleaning unit 816 where an unnecessary Cu film (seed layer) at a peripheral portion of the semiconductor substrate is removed. In the bevel and backside cleaning unit 816, the bevel is etched in a preset time, and Cu adhering to the backside of the semiconductor substrate is cleaned with a chemical liquid such as hydrofluoric acid. At this time, before transferring the semiconductor substrate to the bevel and backside cleaning unit 816, film thickness measurement of the semiconductor substrate may be made by the second aligner and film thickness measuring instrument 842 to obtain the thickness value of the Cu film formed by plating, and based on the obtained results, the bevel etching time may be changed arbitrarily to carry out etching. The region etched by bevel etching is a region which corresponds to a peripheral edge portion of the substrate and has no circuit formed therein, or a region which is not utilized finally as a chip although a circuit is formed. A bevel portion is included in this region.

The semiconductor substrate discharged after cleaning and drying steps in the bevel and backside cleaning unit 816 is transferred by the third robot 833 to the substrate reversing machine 843. After the semiconductor substrate is turned over by the substrate reversing machine 843 to cause the plated surface to be directed downward, the semiconductor substrate is introduced into the annealing unit 814 by the fourth robot 834 for thereby stabilizing a interconnection portion. Before and/or after annealing treatment, the semiconductor substrate is carried into the second aligner and film thickness measuring instrument 842 where the film thickness of a copper film formed on the semiconductor substrate is measured. Then, the semiconductor substrate is carried by the fourth robot 834 into the first polishing apparatus 821 in which the Cu film and the seed layer of the semiconductor substrate are polished.

At this time, desired abrasive grains or the like are used, but fixed abrasive may be used in order to prevent dishing and enhance flatness of the face. After completion of primary polishing, the semiconductor substrate is transferred by the fourth robot 834 to the first cleaning unit 815 where it is cleaned. This cleaning is scrub-cleaning in which rolls having -substantially the same length as the diameter of the semiconductor substrate are placed on the face and the backside of the semiconductor substrate, and the semiconductor substrate and the rolls are rotated, while pure water or deionized water is flowed, thereby performing cleaning of the semiconductor substrate.

After completion of the primary cleaning, the semiconductor substrate is transferred by the fourth robot 834 to the second polishing apparatus 822 where the barrier layer on the semiconductor substrate is polished. At this time, desired abrasive grains or the like are used, but fixed abrasive may be used in order to prevent dishing and enhance flatness of the face. After completion of secondary polishing, the semiconductor substrate is transferred by the fourth robot 834 again to the first cleaning unit 815 where scrub-cleaning is performed. After completion of cleaning, the semiconductor substrate is transferred by the fourth robot 834 to the second substrate reversing machine 844 where the semiconductor substrate is reversed to cause the plated surface to be directed upward, and then the semiconductor substrate is placed on the substrate temporary placing table 845 by the third robot.

The semiconductor substrate is transferred by the second robot 832 from the substrate temporary placing table 845 to the cap plating unit 817 where cap plating is applied onto the Cu surface with the aim of preventing oxidation of Cu due to the atmosphere. The semiconductor substrate to which cap plating has been applied is carried by the second robot 832 from the cap plating unit 817 to the third film thickness measuring instrument 846 where the thickness of the copper film is measured. Thereafter, the semiconductor substrate is carried by the first robot 831 into the second cleaning unit 818 where it is cleaned with pure water or deionized water. The semiconductor substrate after completion of cleaning is returned into the cassette 820a placed on the loading/unloading section 820.

The aligner and film thickness measuring instrument 841 and the aligner and film thickness measuring instrument 842 perform positioning of the notch portion of the substrate and measurement of the film thickness.

The seed layer forming unit 812 may be omitted. In this case, a plated film may be formed on a barrier layer directly in a plated film forming unit 813.

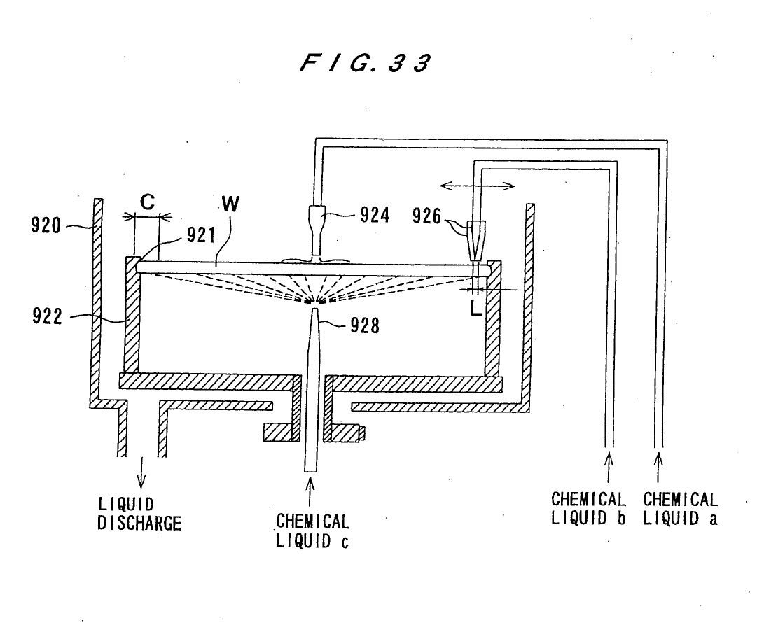

The bevel and backside cleaning unit 816 can perform an edge (bevel) Cu etching and a backside cleaning at the same time, and can suppress growth of a natural oxide film of copper at the circuit formation portion on the surface of the substrate. FIG. 33 shows a schematic view of the bevel and backside cleaning unit 816. As shown in FIG. 33, the bevel and backside cleaning unit 816 has a substrate holding portion 922 positioned inside a bottomed cylindrical waterproof cover 920 and adapted to rotate a substrate W at a high speed, in such a state that the face of the substrate W faces upwardly, while holding the substrate w horizontally by spin chucks 921 at a plurality of locations along a circumferential direction of a peripheral edge portion of the substrate, a center nozzle 924 placed above a nearly central portion of the face of the substrate W held by the substrate holding portion 922, and an edge nozzle 926 placed above the peripheral edge portion of the substrate W. The center nozzle 924 and the edge nozzle 926 are directed downward. A back nozzle 928 is positioned below a nearly central portion of the backside of the substrate W, and directed upward. The edge nozzle 926 is adapted to be movable in a diametrical direction and a height direction of the substrate W.

The width of movement L of the edge nozzle 926 is set such that the edge nozzle 926 can be arbitrarily positioned in a direction toward the center from the outer peripheral end surface of the substrate, and a set value for L is inputted according to the size, usage, or the like of the substrate W. Normally, an edge cut width C is set in the range of 2 mm to 5 mm. In the case where a rotational speed of the substrate is a certain value or higher at which the amount of liquid migration from the backside to the face is not problematic, the copper film within the edge cut width C can be removed.

Next, the method of cleaning with this cleaning apparatus will be described. First, the semiconductor substrate W is horizontally rotated integrally with the substrate holding portion 922, with the substrate being held horizontally by the spin chucks 921 of the substrate holding portion 922. In this state, an acid solution is supplied from the center nozzle 924 to the central portion of the face of the substrate W. The acid solution may be a non-oxidizing acid, and hydrofluoric acid, hydrochloric acid, sulfuric acid, citric acid, oxalic acid, or the like is used. On the other hand, an oxidizing agent solution is supplied continuously or intermittently from the edge nozzle 926 to the peripheral edge portion of the substrate W. As the oxidizing agent solution, one of an aqueous solution of ozone, an aqueous solution of hydrogen peroxide, an aqueous solution of nitric acid, and an aqueous solution of sodium hypochlorite is used, or a combination of these is used.

In this manner, the copper film, or the like formed on the upper surface and end surface in the region of the peripheral edge portion C of the semiconductor substrate W is rapidly oxidized with the oxidizing agent solution, and is simultaneously etched with the acid solution supplied from the center nozzle 924 and spread on the entire face of the substrate, whereby it is dissolved and removed. By mixing the acid solution and the oxidizing agent solution at the peripheral edge portion of the substrate, a steep etching profile can be obtained, in comparison with a mixture of them which is produced in advance being supplied. At this time, the copper etching rate is determined by their concentrations. If a natural oxide film of copper is formed in the circuit-formed portion on the face of the substrate, this natural oxide is immediately removed by the acid solution spreading on the entire face of the substrate according to rotation of the substrate, and does not grow any more. After the supply of the acid solution from the center nozzle 924 is stopped, the supply of the oxidizing agent solution from the edge nozzle 926 is stopped. As a result, silicon exposed on the surface is oxidized, and deposition of copper can be suppressed.

On the other hand, an oxidizing agent solution and a silicon oxide film etching agent are supplied simultaneously or alternately from the back nozzle 928 to the central portion of the backside of the substrate. Therefore, copper or the like adhering in a metal form to the backside of the semiconductor substrate W can be oxidized with the oxidizing agent solution, together with silicon of the substrate, and can be etched and removed with the silicon oxide film etching agent. This oxidizing agent solution is preferably the same as the oxidizing agent solution supplied to the face, because the types of chemicals are decreased in number. Hydrofluoric acid can be used as the silicon oxide film etching agent, and if hydrofluoric acid is used as the acid solution on the face of the substrate, the types of chemicals can be decreased in number. Thus, if the supply of the oxidizing agent is stopped first, a hydrophobic surface is obtained. If the etching agent solution is stopped first, a water-saturated surface (a hydrophilic surface) is obtained, and thus the backside surface can be adjusted to a condition which will satisfy the requirements of a subsequent process.

In this manner, the acid solution, i.e., etching solution is supplied to the substrate to remove metal ions remaining on the surface of the substrate W. Then, pure water is supplied to replace the etching solution with pure water and remove the etching solution, and then the substrate is dried by spin-drying. In this way, removal of the copper film in the edge cut width C at the peripheral edge portion on the face of the semiconductor substrate, and removal of copper contaminants on the backside are performed simultaneously to thus allow this treatment to be completed, for example, within 80 seconds. The etching cut width of the edge can be set arbitrarily (from 2 to 5 mm), but the time required for etching does not depend on the cut width.

Annealing treatment performed before the CMP process and after plating has a favorable effect on the subsequent CMP treatment and on the electrical characteristics of interconnection. Observation of the surface of broad interconnection (unit of several micrometers) after the CMP treatment without annealing showed many defects such as microvoids, which resulted in an increase in the electrical resistance of the entire interconnection. Execution of annealing ameliorated the increase in the electrical resistance. In the presence of annealing, thin interconnection showed no voids. Thus, the degree of grain growth is presumed to be involved in these phenomena. That is, the following mechanism can be speculated: Grain growth is difficult to occur in thin interconnection. In broad interconnection, on the other hand, grain growth proceeds in accordance with annealing treatment. During the process of grain growth, ultra-fine pores in the plated film, which are too small to be seen by the SEM (scanning electron microscope), gather and move upward, thus forming microvoid-like depressions in the upper part of the interconnection. The annealing conditions in the annealing unit 814 are such that hydrogen (2% or less) is added in a gas atmosphere, the temperature is in the range of 300° C. to 400° C., and the time is in the range of 1 to 5 minutes. Under these conditions, the above effects were obtained.

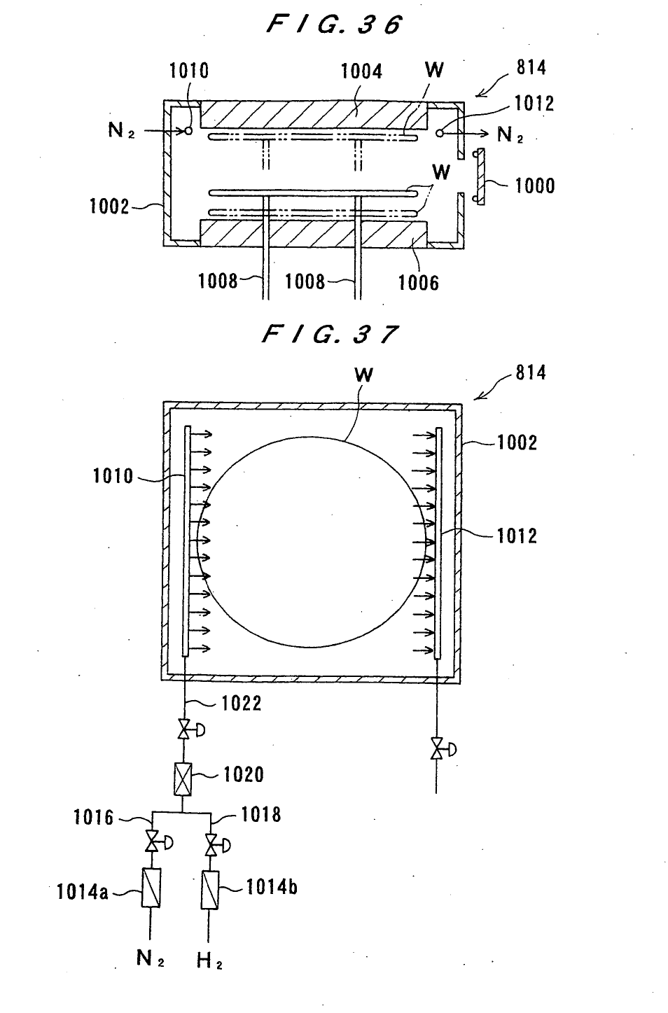

FIGS. 36 and 37 show the annealing unit 814. The annealing unit 814 comprises a chamber 1002 having a gate 1000 for taking in and taking out the semiconductor substrate W, a hot plate 1004 disposed at an upper position in the chamber 1002 for heating the semiconductor substrate W to e.g. 400° C., and a cool plate 1006 disposed at a lower position in the chamber 1002 for cooling the semiconductor substrate W by, for example, flowing a cooling water inside the plate. The annealing unit 814 also has a plurality of vertically movable elevating pins 1008 penetrating the cool plate 1006 and extending upward and downward therethrough for placing and holding the semiconductor substrate W on them. The annealing unit further includes a gas introduction pipe 1010 for introducing an antioxidant gas between the semiconductor substrate W and the hot plate 1004 during annealing, and a gas discharge pipe 1012 for discharging the gas which has been introduced from the gas introduction pipe 1010 and flowed between the semiconductor substrate W and the hot plate 1004. The pipes 1010 and 1012 are disposed on the opposite sides of the hot plate 1004.

The gas introduction pipe 1010 is connected to a mixed gas introduction line 1022 which in turn is connected to a mixer 1020 where a N₂ gas introduced through a N₂ gas introduction line 1016 containing a filter 1014a, and a H₂ gas introduced through a H₂ gas introduction line 1018 containing a filter 1014b, are mixed to form a mixed gas which flows through the line 1022 into the gas introduction pipe 1010.

In operation, the semiconductor substrate W, which has been carried in the chamber 1002 through the gate 1000, is held on the elevating pins 1008 and the elevating pins 1008 are raised up to a position at which the distance between the semiconductor substrate W held on the lifting pins 1008 and the hot plate 1004 becomes e.g. 0.1-1.0 mm. In this state, the semiconductor substrate W is then heated to e.g. 400° C. through the hot plate 1004 and, at the same time, the antioxidant gas is introduced from the gas introduction pipe 1010 and the gas is allowed to flow between the semiconductor substrate W and the hot plate 1004 while the gas is discharged from the gas discharge pipe 1012, thereby annealing the semiconductor substrate W while preventing its oxidation. The annealing treatment may be completed in about several tens of seconds to 60 seconds. The heating temperature of the substrate may be selected in the range of 100-600° C.

After the completion of the annealing, the elevating pins 1008 are lowered down to a position at which the distance between the semiconductor substrate W held on the elevating pins 1008 and the cool plate 1006 becomes e.g. 0-0.5 mm. In this state, by introducing a cooling water into the cool plate 1006, the semiconductor substrate W is cooled by the cool plate to a temperature of 100° C. or lower in e.g. 10-60 seconds. The cooled semiconductor substrate is sent to the next step.

A mixed gas of N₂ gas with several % of H₂ gas is used as the above antioxidant gas. However, N₂ gas may be used singly.

The annealing unit may be placed in the electroplating apparatus.

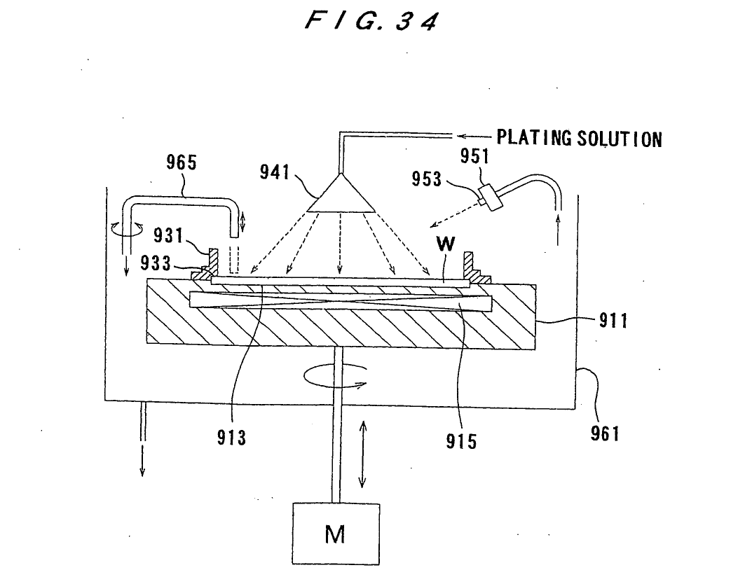

FIG. 34 is a schematic constitution drawing of the electroless plating apparatus. As shown in FIG. 34, this electroless plating apparatus comprises holding means 911 for holding a semiconductor substrate W to be plated on its upper surface, a dam member 931 for contacting a peripheral edge portion of a surface to be plated (upper surface) of the semiconductor substrate W held by the holding means 911 to seal the peripheral edge portion, and a shower head 941 for supplying a plating solution to the surface, to be plated, of the semiconductor substrate W having the peripheral edge portion sealed with the dam member 931. The electroless plating apparatus further comprises cleaning liquid supply means 951 disposed near an upper outer periphery of the holding means 911 for supplying a cleaning liquid to the surface, to be plated, of the semiconductor substrate W, a recovery vessel 961 for recovering a cleaning liquid or the like (plating waste liquid) discharged, a plating solution recovery nozzle 965 for sucking in and recovering the plating solution held on the semiconductor substrate W, and a motor M for rotationally driving the holding means 911. The respective members will be described below.

The holding means 911 has a substrate placing portion 913 on its upper surface for placing and holding the semiconductor substrate W. The substrate placing portion 913 is adapted to place and fix the semiconductor substrate W. Specifically, the substrate placing portion 913 has a vacuum attracting mechanism (not shown) for attracting the semiconductor substrate W to a backside thereof by vacuum suction. A backside heater 915, which is planar and heats the surface, to be plated, of the semiconductor substrate W from underside to keep it warm, is installed on the backside of the substrate placing portion 913. The backside heater 915 is composed of, for example, a rubber heater. This holding means 911 is adapted to be rotated by the motor M and is movable vertically by raising and lowering means (not shown).

The dam member 931 is tubular, has a seal portion 933 provided in a lower portion thereof for sealing the outer peripheral edge of the semiconductor substrate W, and is installed so as not to move vertically from the illustrated position.

The shower head 941 is of a structure having many nozzles provided at the front end for scattering the supplied plating solution in a shower form and supplying it substantially uniformly to the surface, to be plated, of the semiconductor substrate W. The cleaning liquid supply means 951 has a structure for ejecting a cleaning liquid from a nozzle 953.

The plating solution recovery nozzle 965 is adapted to be movable upward and downward and swingable, and the front end of the plating solution recovery nozzle 965 is adapted to be lowered inwardly of the dam member 931 located on the upper surface peripheral edge portion of the semiconductor substrate W and to suck in the plating solution on the semiconductor substrate W.

Next, the operation of the electroless plating apparatus will be described. First, the holding means 911 is lowered from the illustrated state to provide a gap of a predetermined dimension between the holding means 911 and the dam member 931, and the semiconductor substrate W is placed on and fixed to the substrate placing portion 913. An 8 inch substrate, for example, is used as the semiconductor substrate W.

Then, the holding means 911 is raised to bring its upper surface into contact with the lower surface of the dam member 931 as illustrated, and the outer periphery of the semiconductor substrate W is sealed with the seal portion 933 of the dam member 931. At this time, the surface of the semiconductor substrate W is in an open state.

Then, the semiconductor substrate W itself is directly heated by the backside heater 915 to render the temperature of the semiconductor substrate W, for example, 70° C. (maintained until termination of plating). Then, the plating solution heated, for example, to 50° C. is ejected from the shower head 941 to pour the plating solution over substantially the entire surface of the semiconductor substrate W. Since the surface of the semiconductor substrate W is surrounded by the dame member 931, the poured plating solution is all held on the surface of the semiconductor substrate W. The amount of the supplied plating solution may be a small amount which will become a 1 mm thickness (about 30 ml) on the surface of the semiconductor substrate W. The depth of the plating solution held on the surface to be plated may be 10 mm or less, and may be even 1 mm as in this embodiment. If a small amount of the supplied plating solution is sufficient, the heating apparatus for heating the plating solution may be of a small size. In this example, the temperature of the semiconductor substrate W is raised to 70° C., and the temperature of the plating solution is raised to 50° C. by heating. Thus, the surface, to be plated, of the semiconductor substrate W becomes, for example, 60° C., and hence a temperature optimal for a plating reaction in this example can be achieved.

The semiconductor substrate W is instantaneously rotated by the motor M to perform uniform liquid wetting of the surface to be plated, and then plating of the surface to be plated is performed in such a state that the semiconductor substrate W is in a stationary state. Specifically, the semiconductor substrate W is rotated at 100 rpm or less for only 1 second to uniformly wet the surface, to be plated, of the semiconductor substrate W with the plating solution. Then, the semiconductor substrate W is kept stationary, and electroless plating is performed for 1 minute. The instantaneous rotating time is 10 seconds or less at the longest.

After completion of the plating treatment, the front end of the plating solution recovery nozzle 965 is lowered to an area near the inside of the dam member 931 on the peripheral edge portion of the semiconductor substrate W to suck in the plating solution. At this time, if the semiconductor substrate W is rotated at a rotational speed of, for example, 100 rpm or less, the plating solution remaining on the semiconductor substrate W can be gathered in the portion of the dam member 931 on the peripheral edge portion of the semiconductor substrate W under centrifugal force, so that recovery of the plating solution can be performed with a good efficiency and a high recovery rate. The holding means 911 is lowered to separate the semiconductor substrate W from the dam member 931. The semiconductor substrate W is started to be rotated, and the cleaning liquid (ultra-pure water) is jetted at the plated surface of the semiconductor substrate W from the nozzle 953 of the cleaning liquid supply means 951 to cool the plated surface, and simultaneously perform dilution and cleaning, thereby stopping the electroless plating reaction. At this time, the cleaning liquid jetted from the nozzle 953 may be supplied to the dam member 931 to perform cleaning of the dam member 931 at the same time. The plating waste liquid at this time is recovered into the recovery vessel 961 and discarded.

Then, the semiconductor substrate W is rotated at a high speed by the motor M for spin-drying, and then the semiconductor substrate W is removed from the holding means 911.

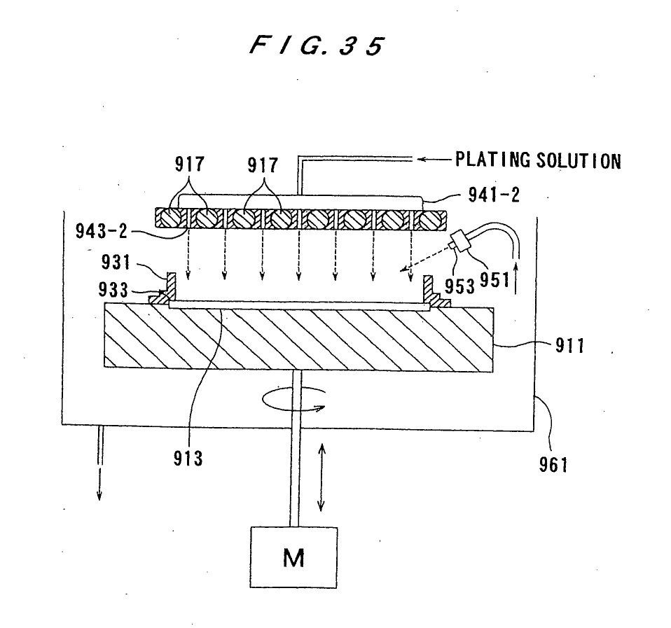

FIG. 35 is a schematic constitution drawing of another electroless plating apparatus. The electroless plating apparatus of FIG. 35 is different from the electroless plating apparatus of FIG. 34 in that instead of providing the backside heater 915 in the holding means 911, lamp heaters 917 are disposed above the holding means 911, and the lamp heaters 917 and a shower head 941-2 are integrated. For example, a plurality of ring-shaped lamp heaters 917 having different radii are provided concentrically, and many nozzles 943-2 of the shower head 941-2 are open in a ring form from the gaps between the lamp heaters 917. The lamp heaters 917 may be composed of a single spiral lamp heater, or may be composed of other lamp heaters of various structures and arrangements.

Even with this constitution, the plating solution can be supplied from each nozzle 943-2 to the surface, to be plated, of the semiconductor substrate W substantially uniformly in a shower form. Further, heating and heat retention of the semiconductor substrate W can be performed by the lamp heaters 917 directly uniformly. The lamp heaters 917 heat not only the semiconductor substrate W and the plating solution, but also ambient air, thus exhibiting a heat retention effect on the semiconductor substrate W.

Direct heating of the semiconductor substrate W by the lamp heaters 917 requires the lamp heaters 917 with a relatively large electric power consumption. In place of such lamp heaters 917, lamp heaters 917 with a relatively small electric power consumption and the backside heater 915 shown in FIG. 33 may be used in combination to heat the semiconductor substrate W mainly with the backside heater 915 and to perform heat retention of the plating solution and ambient air mainly by the lamp heaters 917. In the same manner as in the aforementioned embodiment, means for directly or indirectly cooling the semiconductor substrate W may be provided to perform temperature control.

The cap plating described above is preferably performed by electroless plating process, but may be performed by electroplating process.

Although certain preferred embodiments of the present invention have been shown and described in detail, it should be understood that various changes and modifications may be made therein without departing from the scope of the appended claims.

Industrial Applicability

This invention relates to an electroless plating device and method useful for forming an embedded interconnects that an electric conductor, such as copper or silver, is imbedded in fine recesses for interconnects formed in the surface of a substrate like a semiconductor substrate, and for forming a protective layer for protecting the surface of the interconnects formed in this way.

1. A plating device, comprising:
a processing bath for holding a processing solution to process the substrate by contacting the substrate with the processing solution; and
a substrate holder for holding a substrate in such a state that a back surface of the substrate is sealed and a surface to be plated is brought into contact with the processing solution;
wherein the processing bath has a fluid holding section for holding a fluid having a predetermined temperature which contacts the back surface of the substrate.

2. The plating device according to claim 1, wherein the substrate holder is rotatable and vertically movable.

3. The plating device according to claim 1, wherein the substrate holder is tiltable.

4. The plating device according to claim 1, further comprising:
a head section which can move vertically and can move between a position above the substrate holder at which the head section covers the substrate holder and a retreat position; and
a plating solution supply nozzle provided in the head section.

5. The plating device according to claim 4, wherein the head section is provided with a plating solution holding bath for supplying a predetermined plating solution to the surface of the substrate held by the substrate holder, and a mechanism for keeping the plating solution held in the plating solution holding bath at a predetermined temperature.

6. The plating device according to claim 4, wherein the head section is provided with a pre-plating treatment liquid holding bath for holding a pre-plating treatment liquid and supplying the pre-plating treatment liquid to the surface of the substrate held by the substrate holder.

7. The plating device according to claim 4, wherein the head section is provided with a pure water supply nozzle for supplying pure water to the surface of the substrate held by the substrate holder.

8. The plating device according to claim 1, further comprising a plating solution recovery nozzle for recovering the plating solution supplied to the surface of the substrate held by the substrate holder.

9. The plating device according to claim 4, further comprising an inert gas introduction section for introducing an inert gas adjusted at a predetermined temperature into a space between the substrate held by the substrate holder and the head section, which is in the position covering the upper surface of the substrate.

10. The plating device according to claim 5, further comprising a cleaning liquid introduction section for allowing a cleaning liquid to flow through the plating solution holding bath and the plating solution supply nozzle to clean them.

11. A plating device, comprising:
a processing bath for holding a processing solution to process the substrate by contacting the substrate with the processing solution;
a substrate holder for holding a substrate in such a state that a back surface of the substrate is sealed and a surface to be plated is brought into contact with the processing solution;
a heater for heating the substrate held by the substrate holder;
a plating solution supply section for supplying a plating solution to the surface of the substrate held by the substrate holder; and
a cover body which can cover the surface of the substrate held by the substrate holder.

12. The plating device according to claim 11, further comprising a fluid holding section for holding a fluid having a predetermined temperature which contacts the back surface of the substrate held by the substrate holder to heat the substrate.

13. The plating device according to claim 11, wherein the substrate holder is rotatable and vertically movable.

14. The plating device according to claim 11, wherein the substrate holder is tiltable.

15. The plating device according to claim 11, further comprising:
a head section which can move vertically and can move between a position above the substrate holder at which the head section covers the substrate holder and a retreat position; and
a plating solution supply nozzle provided in the head section.

16. The plating device according to claim 15, wherein the head section is provided with a plating solution holding bath for supplying a predetermined amount of plating solution to the surface of the substrate held by the substrate holder, and a mechanism for keeping the plating solution held in the plating solution holding bath at a predetermined temperature.

17. The plating device according to claim 15, wherein the head section is provided with a pre-plating treatment liquid holding bath for holding a pre-plating treatment liquid and supplying the pre-plating treatment liquid to the surface of the substrate held by the substrate holder.

18. The plating device according to claim 15, wherein the head section is provided with a pure water supply nozzle for supplying pure water to the surface of the substrate held by the substrate holder.

19. The plating device according to claim 15, further comprising a plating solution recovery nozzle for recovering the plating solution supplied to the surface of the substrate held by the substrate holder.

20. The plating device according to claim 15, further comprising an inert gas introduction section for introducing an inert gas adjusted at a predetermined temperature into a space between the substrate held by the substrate holder and the head section, which is in the position covering the upper surface of the substrate.

21. The plating device according to claim 16, further comprising a cleaning liquid introduction section for allowing a cleaning liquid to flow through the plating solution holding bath and the plating solution supply nozzle to clean them.

22. A plating device, comprising:
a processing bath for holding a processing solution to process the substrate by contacting the substrate with the processing solution;
a substrate holder for holding a substrate in such a state that a back surface of the substrate is sealed and a surface to be plated is brought into contact with the processing solution; and
a cover body which can cover the surface of the substrate held by the substrate holder, and which is provided with a heater for preventing heat radiation from the plating solution supplied to the surface of the substrate.

23. The plating device according to claim 22, further comprising a fluid holding section for holding a fluid having a predetermined temperature which contacts the back surface of the substrate held by the substrate holder to heat the substrate.

24. The plating device according to claim 22, wherein the substrate holder is rotatable and vertically movable.

25. The plating device according to claim 22, wherein the substrate holder is tiltable.

26. The plating device according to claim 22, further comprising:
a head section which can move vertically and can move between a position above the substrate holder at which the head section covers the substrate holder and a retreat position; and
a plating solution supply nozzle provided in the head section.

27. The plating device according to claim 26, wherein the head section is provided with a plating solution holding bath for supplying a predetermined amount of plating solution to the surface of the substrate held by the substrate holder, and a mechanism for keeping the plating solution held in the plating solution holding bath at a predetermined temperature.

28. The plating device according to claim 27, wherein the head section is provided with a pre-plating treatment liquid holding bath for holding a pre-plating treatment liquid and supplying the pre-plating treatment liquid to the surface of the substrate held by the substrate holder.

29. The plating device according to claim 26, wherein the head section is provided with a pure water supply nozzle for supplying pure water to the surface of the substrate held by the substrate holder.

30. The plating device according to claim 22, further comprising a plating solution recovery nozzle for recovering the plating solution supplied to the surface of the substrate held by the substrate holder.

31. The plating device according to claim 22, further comprising an inert gas introduction section for introducing an inert gas adjusted at a predetermined temperature into a space between the substrate held by the substrate holder and the head section, which is in the position covering the upper surface of the substrate.

32. The plating device according to claim 27, further comprising a cleaning liquid introduction section for allowing a cleaning liquid to flow through the plating solution holding bath and the plating solution supply nozzle to clean them.

33. A plating device, comprising:
an upwardly-opened plating bath for holding a heated plating solution;
a substrate holder, positioned at the top-opening of the plating bath, for holding a substrate in such a state that a back surface of the substrate is sealed and a surface to be plated is brought into contact with the processing solution; and
a mechanism for immersing the substrate held by the substrate holder in a plating solution in the plating bath.

34. The plating device according to claim 33, wherein the substrate holder includes a stage and a holding portion, which are vertically movable relative to each other, and hold the substrate by covering the back surface of the substrate with the stage and sealing a peripheral portion of the surface of the substrate with a sealing substrate provided in the holding portion.

35. The plating device according to claim 34, wherein the stage has a ring-shaped support frame and a heat conductor in the form of a thin film that is stretched inside the support frame.

36. The plating device according to claim 35, wherein the substrate holder can move up and down relative to the plating bath, and can stop at a pre-heating position for bringing the heat conductor into contact with the plating solution in the plating bath so as to pre-heat the substrate held by the substrate holder and at a plating position for immersing the substrate in the plating solution in the plating bath to carry out plating.

37. The plating device according to claim 33, wherein the plating bath is so constructed that the plating solution is introduced from the bottom of the plating bath into the plating bath, and the plating solution is allowed to overflow the top of the plating bath.

38. A plating device comprising:
an upwardly-opened plating bath for holding a heated plating solution;
a substrate holder, positioned at the top-opening of the plating bath, for holding a substrate in such a state that a back surface of the substrate is sealed and a surface to be plated is brought into contact with the processing solution;
a mechanism for immersing the substrate held by the substrate holder in the plating solution in the plating bath;
a chamber for hermetically closing in a space above the plating bath; and
an inert gas introduction portion for introducing an inert gas into the chamber.

39. A plating treatment apparatus, comprising:
a pre-plating treatment device for carrying out a pre-plating treatment to activate the surface of a substrate before plating;
a plating device for forming a plated film on the activated surface of the substrate;
a post-cleaning device for cleaning the surface of the substrate after the plating;
a cleaning/drying device for rinsing with pure water the surface of the substrate after the post-cleaning treatment; and
a loading/unloading section.

40. A plating method, comprising:
holding a substrate in such a state that a back surface of the substrate is sealed;
pouring a fluid having a predetermined temperature into a fluid holding section so as to contact a back surface of the substrate with the fluid in the fluid holding section; and
processing the substrate by contacting the surface of the substrate held the substrate holder with a processing solution.

41. A plating method comprising:
holding a substrate by a substrate holder;
heating the substrate held by the substrate holder by a plating solution held in a plating bath; and
immersing the heated substrate in the plating solution in the plating bath.

42. The plating method according to claim 41, wherein the substrate is placed and held on the upper surface of a heat conductor, and the heat conductor is allowed to be in contact with the plating solution in the plating bath to thereby heat the substrate.

43. A plating method comprising:
providing a substrate having embedded interconnect in a surface of the substrate, wherein the interconnect is formed by embedding fine recess formed in a surface of the substrate with an electric conductor;
loading the substrate into a plating apparatus housing a transfer device for transferring the substrate;
carrying out a pre-plating treatment of the surface of the substrate;
electroless plating the surface of the substrate to form a protective layer selectively on an exposed surface of the embedded interconnect after said pre-plating treatment;
cleaning the surface of the substrate after said plating; and
unloading the substrate from the plating apparatus after drying the substrate.

44. The plating method according to claim 43, wherein said pre-plating treatment includes a cleaning treatment to clean the surface of the substrate.

45. The plating method according to claim 44, wherein said cleaning treatment is carried out by contacting the surface of the substrate with a cleaning liquid containing H₂SO₄, HF or HCl, and then rinsing the cleaned surface of the substrate.

46. The plating method according to claim 44, wherein said cleaning treatment is carried out by contacting the surface of the substrate with a cleaning liquid containing NH₃ or DMAB, and then rinsing the cleaned surface of the substrate.

47. The plating method according to claim 44, wherein said cleaning treatment is carried out by contacting the surface of the substrate with a cleaning liquid containing oxalic acid, and then rinsing the cleaned surface of the substrate.

48. The plating method according to claim 43, wherein said pre-plating treatment includes a catalyst-imparting treatment to activate the exposed surfaces of the embedded interconnects.

49. The plating method according to claim 48, wherein said catalyst-imparting treatment is carried out by contacting the surface of the substrate with a catalyst-imparting liquid containing PdSO₄ or PdCl₂, and then rinsing the catalyst-imparted surface of the substrate.

50. The plating method according to claim 43, further comprising:
polishing the surface of the embedded interconnect by chemical mechanical polishing prior to said loading the substrate into the plating apparatus.

51. The plating method according to claim 43, wherein said electroless plating is carried out by contacting the surface of the substrate with a plating solution containing a cobalt salt, a tungsten salt, a reducing agent, a complexing agent, a pH buffer and a pH adjusting agent, and then rinsing the plated surface of the substrate.

52. The plating method according to claims 51, wherein said rinsing the plated surface of the substrate comprising rinsing the surface with pure water.

53. The plating method according to claim 43, wherein said electroless plating is carried out by contacting the surface of the substrate with a plating solution which contains nickel ions, a complexing agent for nickel ions and an alkylamine borane or a borohydride compound as a reducing agent for nickel ions, and which is adjusted to a pH of 5-12 by using TMAH, and then rinsing the plated surface of the substrate.

54. The plating method according to claim 53, wherein said rinsing the plated surface of the substrate comprising rinsing the surface with pure water.

55. The plating method according to claim 43, wherein said electroless plating is carried out by contacting the surface of the substrate with a plating solution, which is kept at a temperature of 25 to 90° C., and then rinsing the plated surface of the substrate.

56. The plating method according to claim 55, wherein said rinsing the plated surface of the substrate comprising rinsing the surface with pure water.

57. The plating method according to claim 43, wherein said cleaning the surface of the substrate after said plating comprising cleaning by a pencil sponge.

58. The plating method according to claim 43, wherein said cleaning the surface of the substrate after said plating comprising cleaning with a cleaning liquid jetted or sprayed from a cleaning nozzle.

59. The plating method according to claim 43, wherein the electric conductor is composed of copper or silver, and the protective layer is composed of Co—W—P, Co—W—B, Ni—Co—P, Co—P, Ni—P or Ni—B.

60. The plating method according to claim 43, wherein said protective layer has a thickness in the range of 0.1-500 nm.
